(19) United States
(12) Patent Application Publication
(10) Pub. No.: US 2015/0332171 A1
(43) Pub. Date: Nov. 19, 2015

(54) METHOD OF CREATING RULE INFORMATION, APPARATUS AND STORAGE MEDIUM

(71) Applicant: FUJITSU LIMITED, Kawasaki-shi (JP)

(72) Inventor: Hiroshi NAKAGAWA, Kanazawa (JP)

(73) Assignee: FUJITSU LIMITED, Kawasaki (JP)

(21) Appl. No.: 14/642,109

(22) Filed: Mar. 9, 2015

(30) Foreign Application Priority Data
May 16, 2014 (JP) 2014-102855

(51) Int. Cl. G06N 99/00; G06N 5/02

(52) U.S. Cl. CPC G06N 99/005; G06N 5/027

(57) ABSTRACT

A method of creating rule information, the method includes: from a complex rule defining a complex condition being a combination of conditions on event data individually belonging to each of a plurality of event data classes, and a complex rule defining a predetermined action when the complex condition is satisfied, first extracting a condition on event data belonging to each of the event data classes from the complex condition; and creating an extraction rule for extracting event data to be an application target of the complex rule satisfying the extracted condition from an event data group.

### CROSS-REFERENCE TO RELATED APPLICATION

This application is based upon and claims the benefit of priority of the prior Japanese Patent Application No. 2014-102855, filed on May 16, 2014, the entire contents of which are incorporated herein by reference.

### FIELD

The embodiments discussed herein are related to a method of creating rule information, an apparatus and a storage medium.

### BACKGROUND

To date, a technique called complex event processing (CEP) has been known. The complex event processing is processing for receiving a large volume of events, which are data indicating the occurrence of some phenomena, and for mutually associating the received events in order to make an analysis. In the complex event processing, in order to process a large amount of data efficiently, the processing is sometimes divided into a process of extracting valid data from a data group, and a process of executing the complex event processing on the extracted data. As a related-art technique, for example, a technique is known in which one threshold rule is selected from a plurality of threshold rules stored in a threshold rule database, and a determination is made of whether a network event record violates the selected threshold rule or not. Also, as another related-art technique, a technique is known in which a candidate event is identified based on system configuration information including related information among components, and system history information including fault information output from individual components, then a candidate event is presented, and a detection rule is created based on the presented candidate event.

As examples of related-art techniques, Japanese National Publication of International Patent Application No. 2001-516107, and International Publication Pamphlet No. WO 2010/24133 are known.

### SUMMARY

According to an aspect of the invention, a method of creating rule information, the method includes: from a complex rule defining a complex condition being a combination of conditions on event data individually belonging to each of a plurality of event data classes, and a complex rule defining a predetermined action when the complex condition is satisfied, first extracting a condition on event data belonging to each of the event data classes from the complex condition; and creating an extraction rule for extracting event data to be an application target of the complex rule satisfying the extracted condition from an event data group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an action of an information processing apparatus;

FIG. 2 illustrates an example of a traffic event information collection and detection system;

FIG. 3 illustrates an example of a hardware configuration of a server;

FIG. 4 illustrates an example of a functional configuration of the server;

FIG. 5 illustrates an example of creating a filter engine rule;

FIG. 6 illustrates a specific example of creating a filter engine rule;

FIG. 7 illustrates an example of creation of a condition for discarding all the unused event types;

FIG. 8 illustrates an example of changing filter engine rules by the number of input events per unit time;

FIG. 9 illustrates a specific example of changing filter engine rules by the number of input events per unit time;

FIG. 10 illustrates an example of setting a common condition among all the rules;

FIG. 11 illustrates a specific example of setting a common condition to all the rules;

FIG. 12 illustrates an example of issuing a special event;

FIG. 13 illustrates a specific example of setting a special event;

FIG. 14 illustrates another example of setting a special event;

FIG. 15 illustrates another specific example of setting a special event;

FIG. 16 illustrates an example of setting a special recovery event;

FIG. 17 is a flowchart illustrating an example of an event-input preprocessing procedure;

FIG. 18 is a flowchart illustrating an example of a filter engine rule creation processing procedure at the time of receiving a plurality of CEP engine rules;

FIG. 19 is a flowchart illustrating an example of a CEP engine rule creation processing procedure for a special event and a special recovery event; and

FIGS. 20, 21 and 22 are flowcharts illustrating an example of an event-input time processing procedure.

### DESCRIPTION OF EMBODIMENTS

With a related-art technique, it takes time and effort to create a rule for extracting valid data from a data group. For example, a rule creator has to create a rule for extracting valid data from a data group while keeping consistency with a rule for analyzing the data group, and thus it takes time and effort of the rule creator.

In the following, a detailed description will be given of embodiments of the disclosed information processing apparatus, and rule creation method with reference to the drawings.

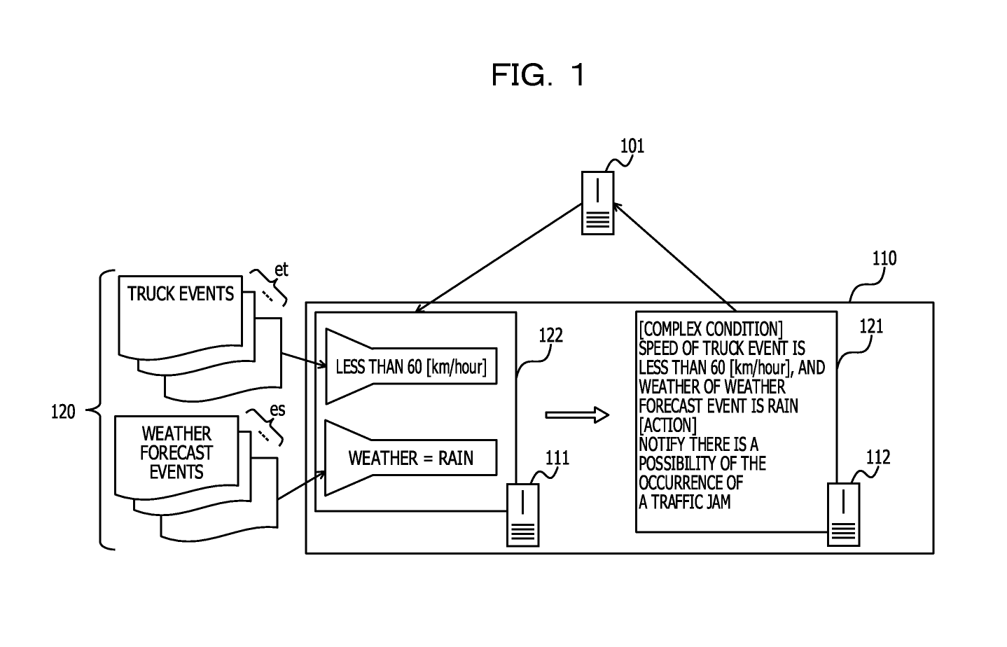

FIG. 1 illustrates an example of an action of an information processing apparatus 101. The information processing apparatus 101 is a computer that creates a rule. Specifically, the information processing apparatus 101 creates an extraction rule 122 that extracts event data from an event data group 120.

An event data group is a set of event data that belong to each of a plurality of event data classes. An event data class classifies event data by their type and item. Event data is data that indicates the occurrence of some phenomenon. For example, one piece of event data has information indicating any one of event data classes to which the event data belongs among a plurality of event data classes, and property values of 0 or more properties. Specifically, event data indicating that a car passed through a certain observation point at a speed of 60 [km/hour] produces data indicating that the event data class is a car event, and the property value of a speed property is 60 [km/hour]. Also, an event data group has a plurality of keys as a plurality of event data classes, and may be a data set having a pair of each key of a plurality of keys, and a value of each key. In the following description, for the sake of simplification, “event data” is simply called an “event”. Also, an “event data group” is simply called an “event group”. Also, an “event data class” is called an “event type”.

FIG. 1 illustrates a complex event processing system 110 that performs complex event processing. The complex event processing system 110 includes an extraction unit 111 that extracts an event from an event group 120, and an analysis unit 112 that combines the events extracted by the extraction unit 111, and analyzes them. The extraction unit 111 and the analysis unit 112 may be the same apparatus. Further, the information processing apparatus 101 and the extraction unit 111 may be the same apparatus, and the information processing apparatus 101 and the analysis unit 112 may be the same apparatus.

A designer of the complex event processing system 110 provides an extraction rule 122 used by the extraction unit 111, and a complex rule 121 used by the analysis unit 112. The complex rule 121 defines a complex condition produced by combining conditions on the events belonging to each of a plurality of event types, and a predetermined action when the complex condition is satisfied. A condition is a logical expression using a property value of an event belonging to one event type. Also, the condition may be a logical expression regarding an event itself, that is to say, whether there is an event belonging to one event type, or not. A complex condition is a logical expression using a property value of an event belonging to two or more event types, or a logical expression concerning an event itself. The complex rule is expressed by an event processing language (EPL), for example. The designer of the complex event processing system 110 creates an extraction rule while maintaining consistency with the complex rule, and thus the development cost of the rule becomes high.

Also, whether an extraction rule is correctly created or not depends on a rule creation skill of the designer of the complex event processing system 110, a created extraction rule might not become an extraction rule that extracts only a valid event, and suitable event extraction might not be carried out. If suitable event extraction is not preformed, and for example, the created extraction rule includes an event that is to be originally discarded in addition to a valid event to be originally used for analysis, the processing load demanded by the analysis unit 112 increases. Also, if a created extraction rule has discarded a valid event to be used for an analysis, the precision of an analysis result by the analysis unit 112 becomes worse.

Thus, the information processing apparatus 101 extracts each event type condition from a complex rule including a complex condition produced by combining the conditions of each event type of a plurality of event types, and creates an extraction rule that extracts data satisfying the condition of each event type. Thereby, it is possible for the information processing apparatus 101 to automatically create the extraction rule, and to reduce the load of the rule creation work by the designer of the complex event processing system 110.

The complex event processing system 110 illustrated in FIG. 1 receives truck events et indicating phenomena in which a truck has passed a certain observation point, and weather forecast events es indicating phenomena in which the weather forecast at a certain observation point has changed as an event group 120. Also, the complex condition of the complex rule 121 created by the designer of the complex event processing system 110 is the condition that the speed of the truck event is less than 60 [km/hour], and the weather of the weather forecast event is rain. Also, the action of the complex rule 121 is to notify “There is a possibility of the occurrence of a traffic jam”.

The information processing apparatus 101 extracts a condition concerning an event of each data class correspondingly to each event from the complex condition based on the complex rule 121. Specifically, for example, the information processing apparatus 101 extracts a condition of “the speed is less than 60 [km/hour]” from the complex condition with respect to the truck event et, and extracts a condition of “the weather is rain” with respect to the weather forecast event es.

Then, the information processing apparatus 101 creates an extraction rule that extracts the events to which the complex rule satisfying the extracted condition is applied from the event group 120. For example, the information processing apparatus 101 creates the extraction rule 122 that extracts the truck event et satisfying the condition of “the speed is less than 60 [km/hour]” from the event group 120, and extracts the weather forecast event es satisfying the condition of “the weather is rain”.

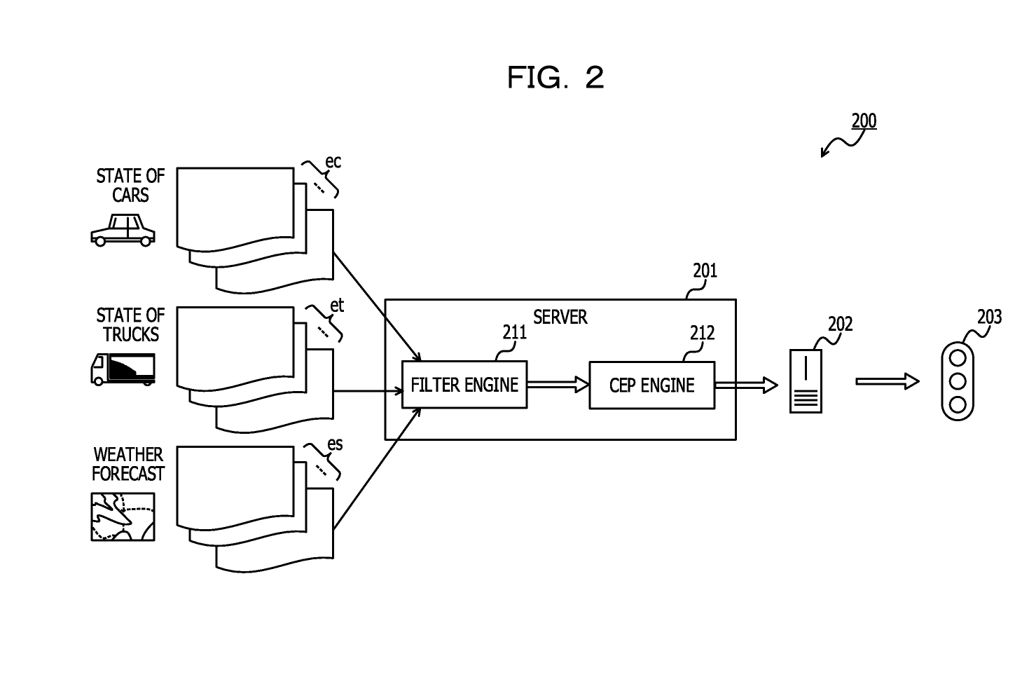

Next, a description will be given of an example in which the complex event processing system 110 is applied to a traffic event information collection and detection system 200 using FIG. 2.

FIG. 2 illustrates an example of the traffic event information collection and detection system 200. The traffic event information collection and detection system 200 includes a complex event processing server 201, a traffic light and traffic sign control server 202, and a traffic light 203. The complex event processing server 201 corresponds to the information processing apparatus 101 illustrated in FIG. 1.

The complex event processing server 201 receives a large volume of events, such as car events ec indicating the state of cars at the observation point, truck events et indicating the state of trucks at the observation point, and weather forecast events es indicating the state of weather forecast at the observation point. Then, the complex event processing server 201 filters the received events, and analyzes the received events in association with one another. The complex event processing server 201 transmits matters to be taken action by the traffic light and traffic sign control server 202 from the analysis result to the traffic light and traffic sign control server 202 as a recommendation. The traffic light and traffic sign control server 202 controls the traffic light 203 and the traffic sign in accordance with the recommendation.

In the following, for the sake of simplification, a complex event processing server is called a “server”. Also, in the following description and drawings, a car event is sometimes described as “CarEvent”. In the same manner, a truck event is sometimes described as “TrackEvent”. In the same manner, a weather forecast event is sometimes described as “SensorEvent”.

The server 201 includes a filter engine 211 that performs filtering on events in order to process a large volume of events, and a CEP engine 212 that associates the filtered events with one another, and makes an analysis. The filter engine 211 and the CEP engine 212 are processes. Thereby, it is possible for the server 201 to reduce the number of events to which the CEP engine 212 is applied. The designer of the traffic event information collection and detection system 200 provides a “filter engine rule”, which is a rule for the filter engine 211, and a “CEP engine rule”, which is a rule for the CEP engine 212. The filter engine rule corresponds to the extraction rule 122 illustrated in FIG. 1. Also, the CEP engine rule corresponds to the complex rule 121 illustrated in FIG. 1.

However, there are the following three problems in addition to the problems described with FIG. 1. The first problem is that with a change of input events, the optimality of the filter engine rule set at first is sometimes deteriorated.

For example, it is assumed that a truck event et was a valid event, and a car event ec was discarded at the time of setting a filter engine rule. However, there is a state in which the car event ec ought to be a valid event, and the truck event et ought to be discarded with the lapse of time. An example of such a state is as follows. At the time of setting a filter engine rule, a large-scale land development was carried out at the observation point, and thus the amount of truck traffic was large, which was causing a traffic jam. Accordingly, the truck event was determined to be a valid event. However, when the land development came to an end at the observation point with the lapse of time, the amount of truck traffic decreases, and the amount of car traffic increases instead. Here, if both the truck event et and the car event ec are attempted to be evaluated by the CEP engine, the load of the CEP engine increases, and thus the operation cost of the apparatus that performs the complex event processing becomes high.

The second problem is that if the filter engine rule has detected an event that does not satisfy the CEP engine rule, it is not possible to discard all the events, and thus it is not possible to reduce the load of the complex event processing apparatus.

The third problem is that if the number of events that hit the filter engine rule increases, the processing load of the CEP engine increases, and thus the processing performance of the complex event processing deteriorates.

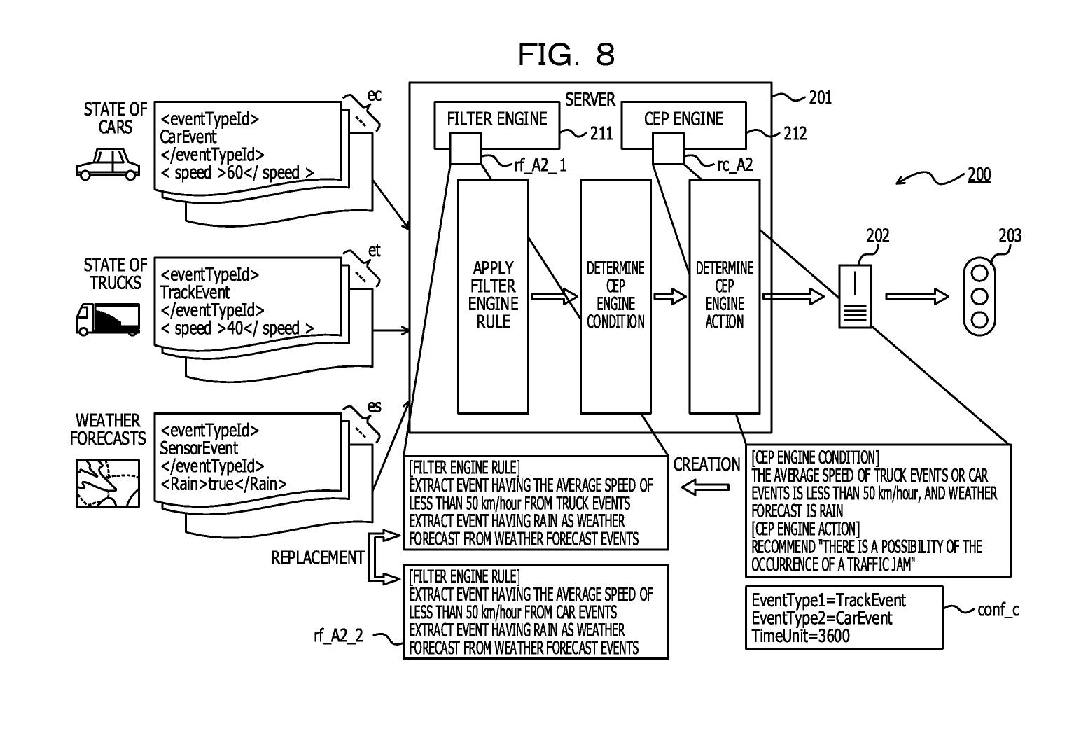

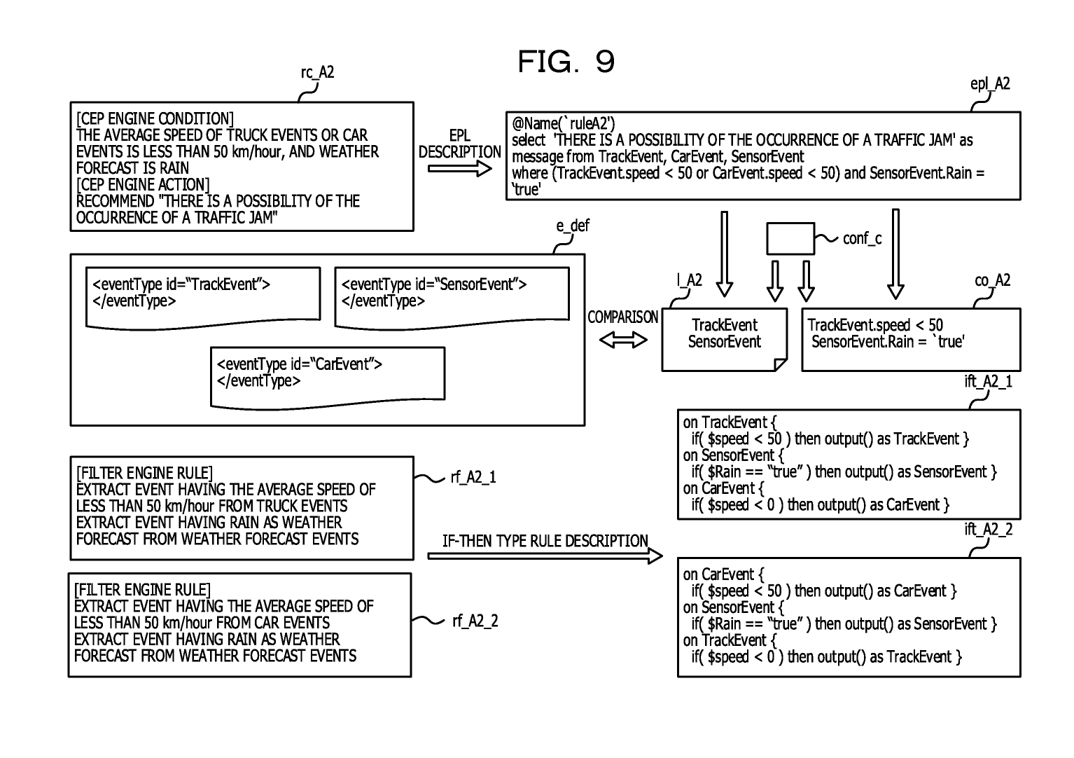

Thus, the server 201 solves the first problem by dynamically changing the filter engine rule. An example of dynamically changing the filter engine rule is described later using FIG. 8 and FIG. 9.

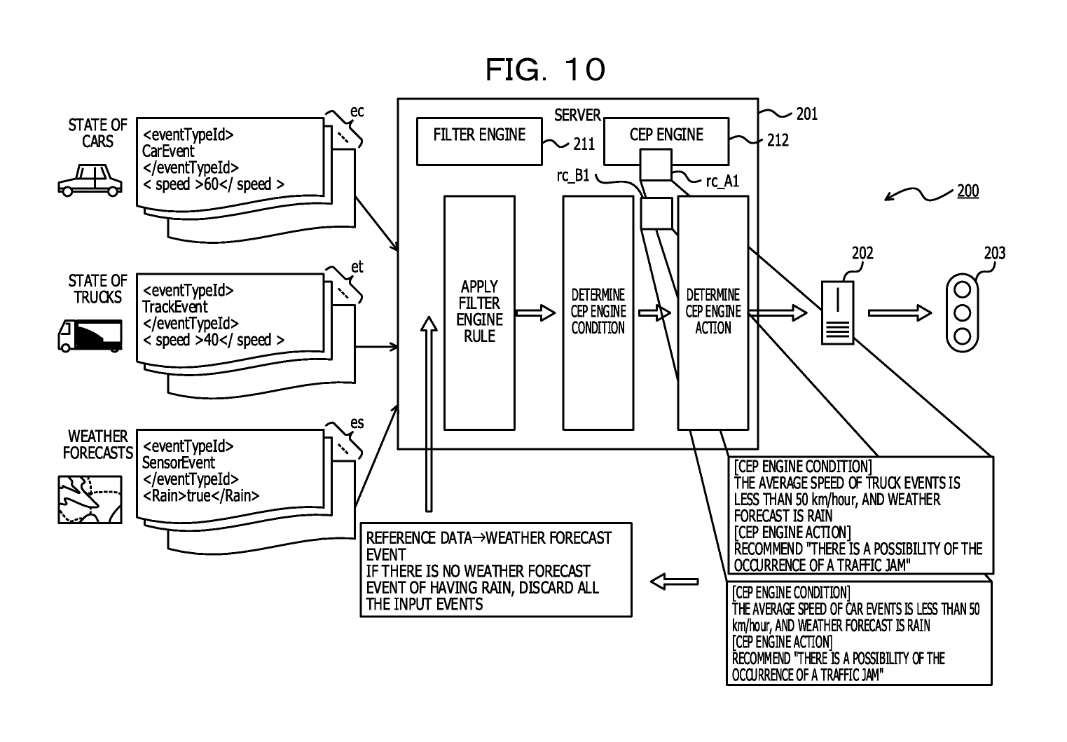

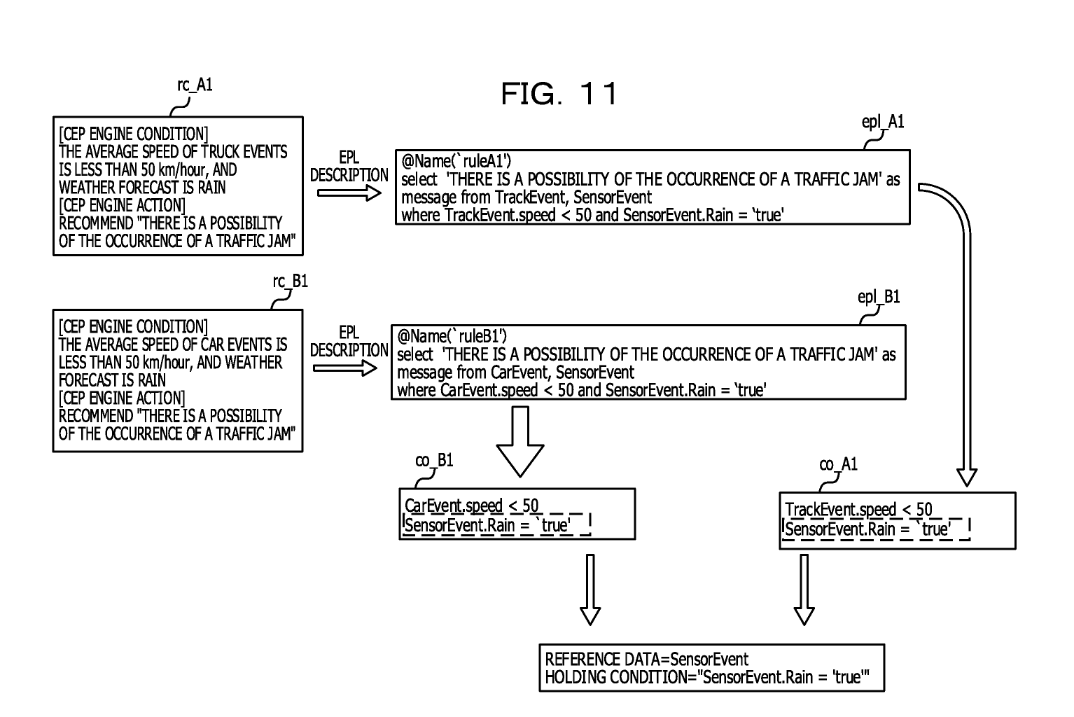

Also, if there are a plurality of CEP engine rules, the server 201 solves the second problem by setting a common condition to all the CEP engine rules, and discarding all the events when the common condition is not satisfied. An example of setting a common condition to all the CEP engine rules, and if the common condition is not satisfied, discarding all the events is described later using FIG. 10 and FIG. 11.

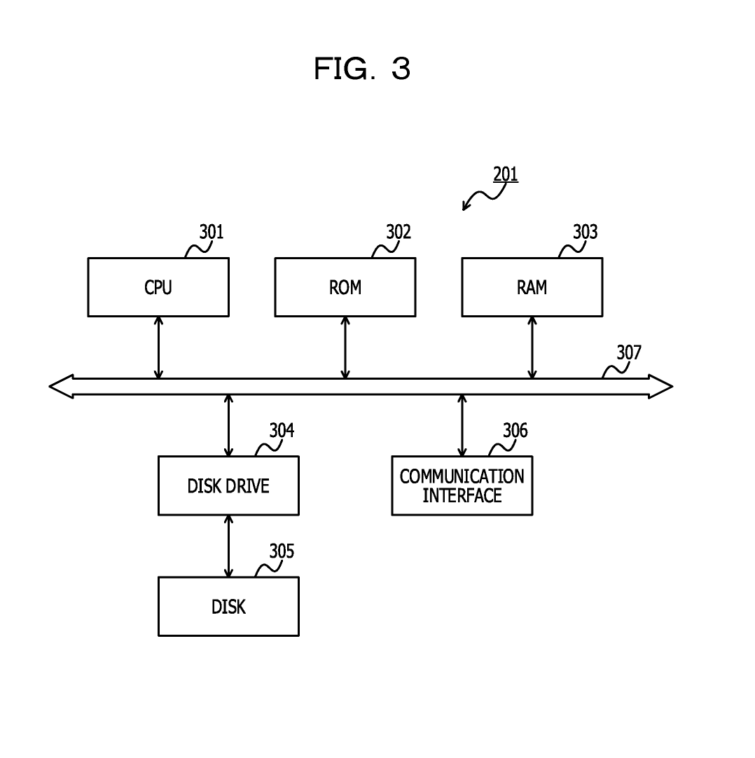

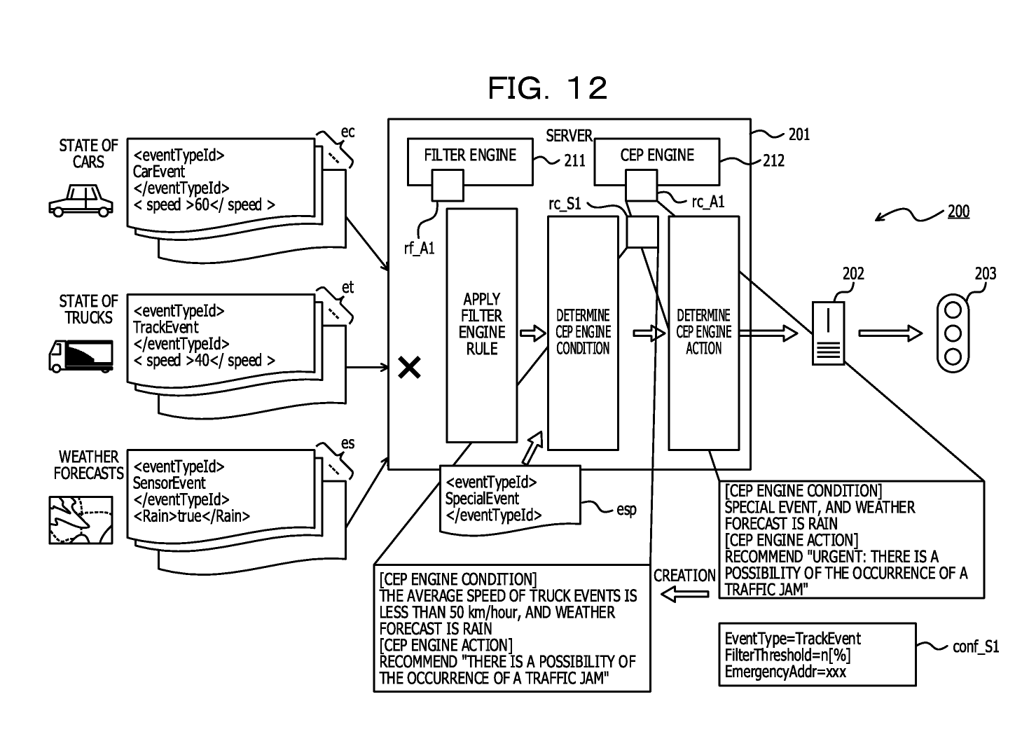

Also, the server 201 solves the third problem by discarding events belonging to the event type when a filtering rate per unit time of a certain event type is decreased, and issuing a special event. An example of discarding events belonging to the event type when a filtering rate per unit time of a certain event type is decreased, and issuing a special event is described later using FIG. 12 to FIG. 16. Next, a description will be given of a hardware configuration of the server 201 using FIG. 3.

FIG. 3 illustrates an example of a hardware configuration of the server 201. In FIG. 3, the server 201 includes a central processing unit (CPU) 301, a read only memory (ROM) 302, and a random access memory (RAM) 303. Also, the server 201 includes a disk drive 304 and a disk 305, and a communication interface 306. Also, the CPU 301, the ROM 302, the RAM 303, the disk drive 304, the disk 305, and the communication interface 306 are individually coupled through a bus 307.

The CPU 301 is a processor that performs overall control of the server 201. The ROM 302 is a nonvolatile memory that stores programs, such as a boot program, and the like. The RAM 303 is a volatile memory that is used as a work area of the CPU 301.

The disk drive 304 is a control unit that controls data read and write on the disk 305 under the control of the CPU 301. For the disk drive 304, it is possible to employ a magnetic disk drive, a solid-state drive, or the like, for example. The disk 305 is a nonvolatile memory that stores data written under the control of the disk drive 304. For example, if the disk drive 304 is a magnetic disk drive, it is possible to employ a magnetic disk for the disk 305. Also, if the disk drive 304 is a solid-state drive, it is possible to employ a so-called semiconductor disk, which is a semiconductor memory formed by a semiconductor device, for the disk 305.

The communication interface 306 is a control unit that performs interface between a network and the inner parts, and controls input and output of data from and to the other apparatuses. The communication interface 306 is coupled to the other apparatuses through a network via a communication line. For the communication interface 306, it is possible to apply a modem, a local area network (LAN) adapter, or the like, for example.

Also, if the administrator of the traffic event information collection and detection system 200 directly operates the server 201, the server 201 may include hardware, such as a display unit, a keyboard, and a mouse.

Example of functional configuration of server 201

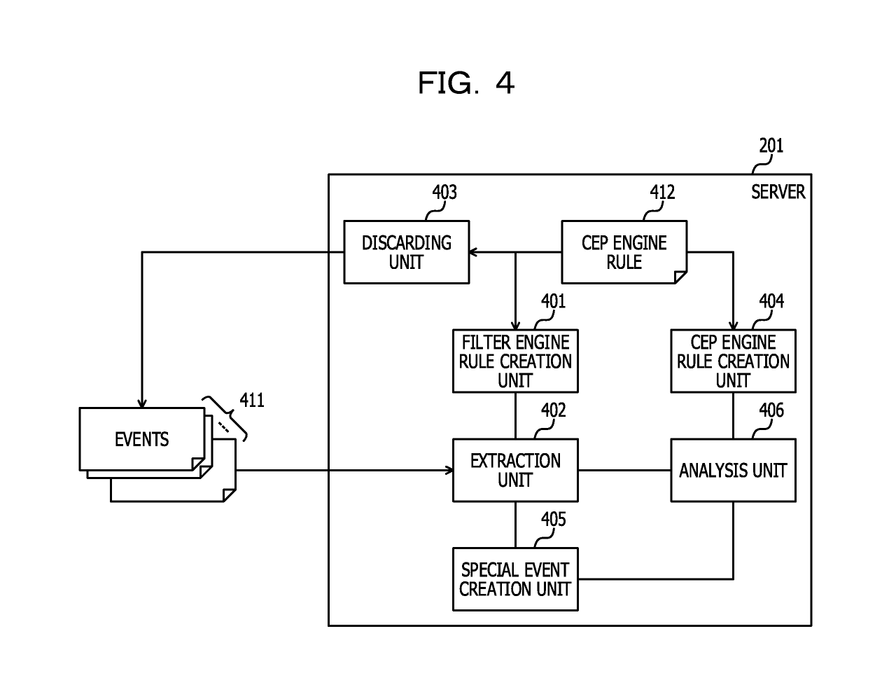

FIG. 4 illustrates an example of a functional configuration of the server 201. The server 201 includes a filter engine rule creation unit 401, an extraction unit 402, a discarding unit 403, a CEP engine rule creation unit 404, a special event creation unit 405, and an analysis unit 406. The extraction unit 402 corresponds to the filter engine 211. Also, the analysis unit 406 corresponds to the CEP engine 212.

The filter engine rule creation unit 401, the extraction unit 402, the discarding unit 403, the CEP engine rule creation unit 404, the special event creation unit 405, and the analysis unit 406, which become the control units, are achieved by the CPU 301 executing the programs stored in the storage device. The storage device is, for example the ROM 302, the RAM 303, the disk 305, and the like illustrated in FIG. 3. Also, the processing result of each unit is stored in a register held by the CPU 301, a RAM 303, or the like.

Also, the server 201 is capable of accessing a received event group 411, and a CEP engine rule 412 created by a designer of the traffic event information collection and detection system 200. The CEP engine rule 412 is the data that defines a complex condition that is produced by combining conditions concerning the events belonging to each of a plurality of event types, and a predetermined action when the complex condition is satisfied. The event group 411, and the CEP engine rule 412 are stored in the storage device, such as the RAM 303, or the disk 305.

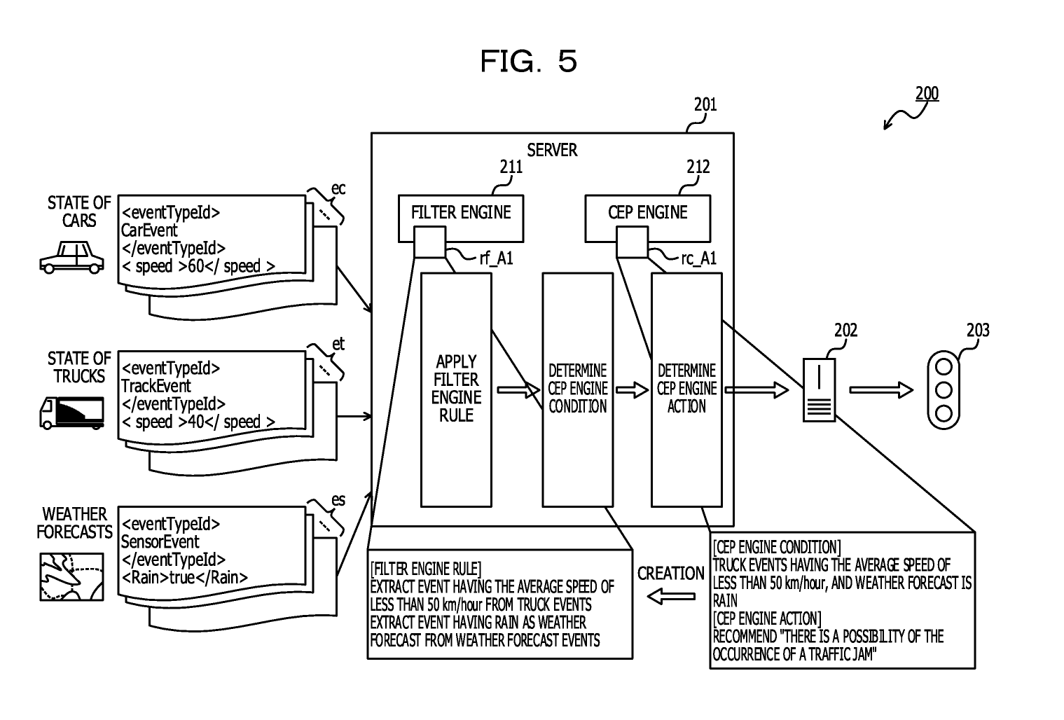

The filter engine rule creation unit 401 extracts the conditions concerning the events belonging to each event type corresponding to each of the event types from the complex condition based on the CEP engine rule 412. Then, the filter engine rule creation unit 401 creates a filter engine rule that extracts events to which the CEP engine rule 412 satisfying the extracted conditions is applied from the event group 411. Examples of creation of specific filter engine rules are illustrated in FIG. 5 to FIG. 7.

The extraction unit 402 applies the filter engine rule created by the filter engine rule creation unit 401 to the event group 411 so as to extract events to which the CEP engine rule 412 is applied from the event group 411.

The filter engine rule creation unit 401 may create a filter engine rule that extracts events belonging to any one of a plurality of event types based on the number of events belonging to each event type. Then, the extraction unit 402 may apply the filter engine rule created by the filter engine rule creation unit 401 to the event group 411. The number of events belonging to each event type is the number of events for each event type, and for example, the number of truck events et, the number of car events ec, and the number of weather forecast events es. For example, the extraction unit 402 applies a filter engine rule that extracts events belonging to the event type, which has the maximum number of events belonging to an event type, to the event group 411. Also, the extraction unit 402 may apply a filter engine rule that extracts events belonging to an event type, which has the maximum or the second largest number of events belonging to the event type, to the event group 411.

The discarding unit 403 extracts a condition concerning events belonging the event type common to each complex condition of the plurality of CEP engine rules from a plurality of CEP engine rules. Then, the discarding unit 403 extracts the condition concerning the events belonging to the common event type, and then if there are no events satisfying the condition concerning the events belonging to the event type common to the event group 411, the discarding unit 403 discards the event group 411. An example of discarding the specific event group 411 is illustrated in FIG. 8 and FIG. 9.

The CEP engine rule creation unit 404 creates a new CEP engine rule based on the predetermined threshold value corresponding to the specific event type, and the CEP engine rule 412. Here, the complex condition defined by the new CEP engine rule is a condition produced by combining a condition including the specific data, and a condition concerning the events belonging to a different event type from the specific event type included in the CEP engine rule 412. The specific data is the data based on a comparison result between the number of extracted event data belonging to the specific event type, and the data based on the predetermined threshold value. In the present embodiment, for the specific events, the special events belonging to the event type defined in advance by the complex event processing server 201, and the special recovery events are used.

The special event is an event that is issued when the number of extracted events belonging to the specific event type by applying the filtering rule is over a predetermined threshold value. Also, the special recovery event is issued when the number of extracted events belonging to the specific event type by applying the filtering rule becomes lower than the predetermined threshold value after issuing a special event. For the special event, and the special recovery event, descriptions will be given later using FIG. 12 to FIG. 16.

In the present embodiment, for example, it is assumed that the complex condition of the CEP engine rule 412 is “the average speed of the truck events is less than 50 km/hour, and the weather forecast is rain”, and the action is “to recommend “There is a possibility of the occurrence of a traffic jam””. Also, it is assumed that the specific event type is the truck event, and the predetermined threshold value is 50 [%]. The specific event type, and the predetermined threshold value are set in the special event configuration. A description will be given of an example of the special event configuration using FIG. 12. At this time, the CEP engine rule creation unit 404 creates a new CEP engine rule that defines the complex condition in which there is a “special event, and the weather forecast is rain”, and the action to recommend “Urgent: “There is a possibility of the occurrence of a traffic jam””.

When the special event creation unit 405 applies the filter engine rule to the event group 411, the special event creation unit 405 creates specific data based on the comparison result between the number of extracted events to which the filter engine rule has been applied, and a predetermined threshold value. For example, if the number of extracted events by applying the filtering rule is over the predetermined threshold value, the special event creation unit 405 creates a special event. Also, for example, after the special event creation unit 405 created a special event, if the number of extracted events by applying the filtering rule becomes less than the predetermined threshold value, the special event creation unit 405 creates a special recovery event.

Also, when the special event creation unit 405 applies the filter engine rule to the event group 411, if the number of extracted events is higher than the predetermined threshold value, the special event creation unit 405 may discard event data belonging to a specific event type among the event group 411.

The analysis unit 406 applies the CEP engine rule 412 to the events extracted by the extraction unit 402 so as to analyze the event group 411. Also, the analysis unit 406 may set the events extracted by the extraction unit 402, and the special event and the special recovery event that are created by the special event creation unit 405 to application targets of the new CEP engine rule created by the CEP engine rule creation unit 404. Also, it is assumed that the special event creation unit 405 has discarded event data belonging to a specific event type among the event group 411. In this case, the analysis unit 406 may set the events that have not been discarded among the events extracted by the extraction unit 402, the special event, and the special recovery event to application targets of the new CEP engine rule. Specifically, the control process of the server 201 first notifies the CEP engine 212 to apply the new CEP engine rule. Then, the filter engine 211 outputs the events that have not been discarded among the events extracted by the extraction unit 402, the special event, and the special recovery event to the CEP engine 212 so as to set those events to application targets of the new CEP engine rule.

FIG. 5 illustrates an example of creating a filter engine rule. The server 201 performs syntax analysis on the CEP engine rule set by the designer to create a filter engine rule. Next, the server 201 extracts an event type to be used by the CEP engine rule from the analysis result by the CEP engine rule. Then, the server 201 creates a filter engine rule including the condition of the events to be extracted correspondingly to the event type from the extracted event type, and the condition to discard the unused event type.

The CEP engine rule rc_A1 illustrated in FIG. 5 has the CEP engine condition that states “the average speed of the truck event is less than 50 km/hour, and the weather forecast is rain”, and the CEP engine action that states “to recommend “There is a possibility of the occurrence of a traffic jam””. Next, the server 201 extracts the truck event and the weather forecast event from the CEP engine rule rc_A1 as the event type to use. Then, the server 201 creates the filter engine rule rf_A1 from the extracted event type. The filter engine rule rf_A1 is a rule that extracts events having the average speed of less than 50 km/hour from the truck events, and extracts events having rain from the weather forecast events. Also, the filter engine rule rf_A1 includes discarding all the unused car events.

When events are input, the filter engine 211 applies the filter engine rule rf_A1 to extract events. Specifically, the filter engine 211 extracts the events whose average speed is less than 50 km/hour from the truck events et, and the events having rain from the weather forecast events es, but the filter engine 211 discards all the car events ec. The CEP engine 212 applies the CEP engine rule rc_A1 to the events extracted by the filter engine 211 to determine whether the CEP engine condition is satisfied. If it is satisfied, the CEP engine 212 determines to execute the CEP engine action. In the example in FIG. 5, for example, the server 201 recommends “There is a possibility of the occurrence of a traffic jam” to the traffic light and road traffic sign control server 202. The traffic light and road traffic sign control server controls the traffic light 203 and the road traffic sign in order to dissolve the traffic jam.

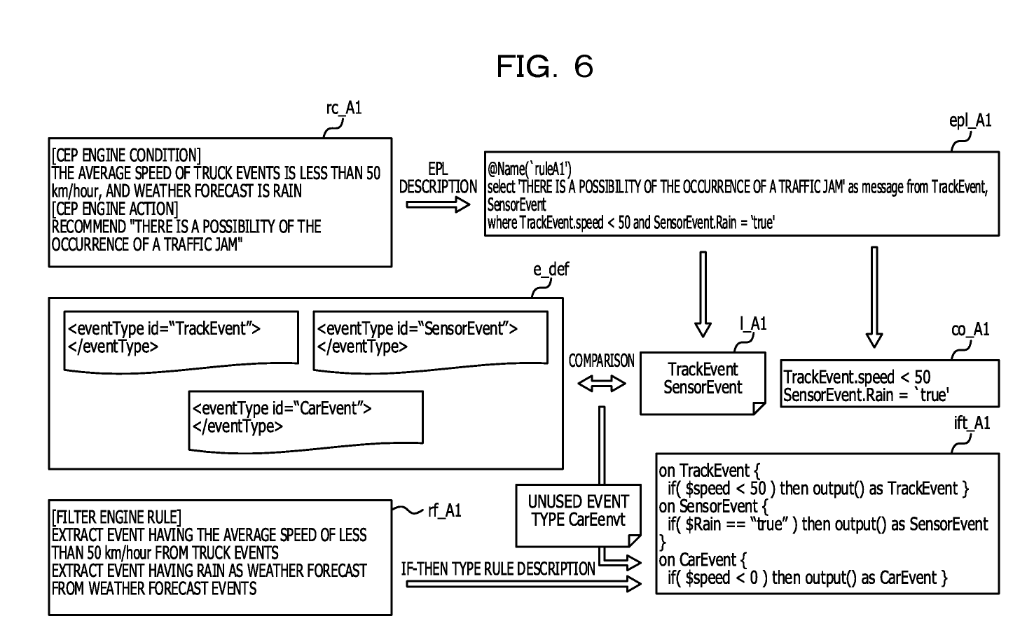

FIG. 6 illustrates a specific example of creation of a filter engine rule. FIG. 6 illustrates the specific example illustrated in FIG. 5. The CEP engine rule rc_A1 becomes code epl_A1 illustrated in FIG. 6 in the EPL description. The server 201 extracts a truck event, and a weather forecast event from the code epl_A1 as use event type. The extracted result is a list l_A1 illustrated in FIG. 6.

Then, the server 201 compares with the type of the event type input into the server 201, and identifies an unused event type. The type of the event type that is input into the server 201 is set in advance. In the example in FIG. 6, the event type definition e_def illustrates the type of the input event type. Specifically, the event type definition e_def illustrates that the type of the input event type includes a truck event, a weather forecast event, and a car event. The server 201 compares the event type definition e_def with the list l_A1, and identifies a car event as an unused event type.

Also, the server 201 extracts a condition for each event type from the where clause of the code epl_A1. Specifically, the server 201 extracts “TrackEvent.speed<50” as the condition of the truck event from the where clause of the code epl_A1, and extracts “SensorEvent.Rain=‘true’” as the weather forecast event. The result of extracting the condition is the condition extraction result co_A1 illustrated in FIG. 6.

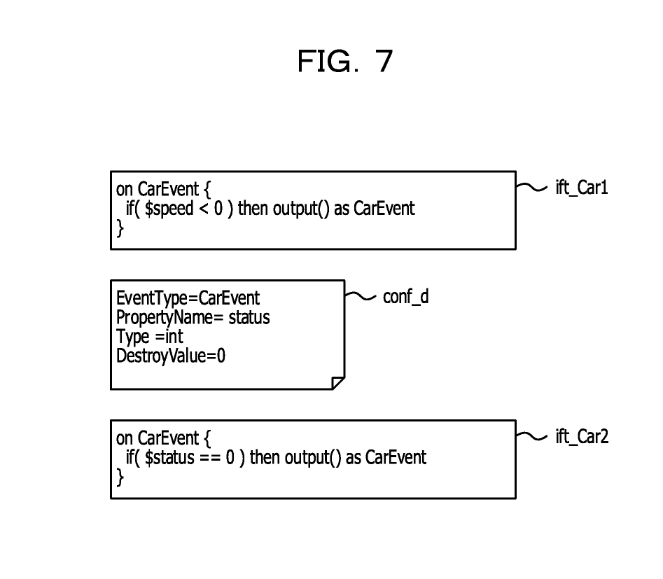

The server 201 creates the filter engine rule rf_A1 from the condition extraction result co_A1, and the identified unused event type. The filter engine rule rf_A1 becomes code ift_A1 illustrated in FIG. 6 in the IF-THEN type rule description. The code ift_A1 defines the condition illustrated by the condition extraction result co_A1 concerning the truck event, and the weather forecast event. Also, the code ift_A1 defines the condition for discarding all the car events concerning the car event, which is an unused event type, by specifying less than zero for the speed range, which is not possible. Next, an example of creating the condition of discarding all the unused event types in the IF-THEN type rule is illustrated using FIG. 7.

FIG. 7 illustrates an example of creation of a condition for discarding all the unused event types. As a first example of the condition for discarding all the unused event type, the server 201 creates a rule that defines the range having a property value of the event type, which is not possible, by the event type definition in the IF-THEN type rule. For example, the data type of the speed of the car event is defined by the int type with a sign, and thus the speed does not become less than zero. Accordingly, the server 201 defines the condition for discarding all the car events by defining less than zero. The created result is code ift_Car1 illustrated in FIG. 7. The information that the speed does not become less than zero is set by the administrator of the traffic event information collection and detection system 200 as the initial setting, for example.

Also, it might be possible to take all the property values in the range allowed for the property type of an event type. As a second example of the condition of discarding all the unused event types in such a case, an event type may be provided with a discarding condition property, and the condition of discarding all the unused event types may be created by specifying the property value for the discarding condition.

Specifically, for example, the server 201 stores a discarding condition setting configuration, which was set by an administrator of the traffic event information collection and detection system 200. The discarding condition setting configuration has setting items, such as EventType, PropertyName, Type, and DestroyValue. In EventType, an event type to be discarded is set. In PropertyName, a property to become the discarding condition is set. In Type, a type of the property to become the discarding condition is set. In DestroyValue, a property value to become the discarding condition at the time of discarding is set. For example, the discarding condition setting configuration conf_d, illustrated in FIG. 7, has a setting in which if the status property of CarEvent is 0, the relevant CarEvent is discarded. Then, the server 201 refers to the discarding condition setting configuration conf_d, and creates a filter engine rule defining the condition of discarding all the car events.

The created result is code ift_Car2 illustrated in FIG. 7. Here, it is assumed that values other than 0 are input into the status properties of all the car events. Accordingly, there is no car event having the status property of 0, and thus it is possible for the server 201 to discard all the car events using the code ift_Car2.

Next, a description will be given of an example in which filter engine rules are changed in accordance with the number of input events per unit time in order to solve the first problem illustrated in FIG. 2 using FIG. 8 and FIG. 9.

FIG. 8 illustrates an example of changing filter engine rules by the number of input events per unit time. The server 201 changes filter engine rules in accordance with the number of input events per unit time in addition to the functions illustrated in FIG. 5. Specifically, the server 201 refers to the dynamically change configuration set by the administrator of the traffic event information collection and detection system 200, and changes the filter engine rules.

The dynamically change configuration has setting items, such as EventType1, EventType2, and TimeUnit. EventType1 is an event type to which filter engine rules are to be changed. In EventType1, a first event type to be used by default is set. EventType2 is an event type to which filter engine rules are to be changed. EventType2 is a second event type to be used when the number of inputs becomes larger than the number of inputs of the first event type. In TimeUnit, a unit time of the number of input events is stored.

For example, the dynamically change configuration conf_c illustrated in FIG. 8 includes a truck event as the first event type, a car event as the second event type, and 3600 seconds as the unit time of the number of input events. In the following, if there is a dynamically change configuration, it is expressed that “a “dynamically change condition” is set”. Here, “the dynamically change condition is satisfied” means the case where the number of inputs per unit time of events of the currently unused event type out of the first event type or the second event type is larger than the number of inputs of the events belonging to the currently in-use event type.

If a dynamically change condition is set, the server 201 creates a filter engine rule that defines the condition of the first event type, and a filter engine rule that defines the condition of the second event type. The CEP engine rule rc_A2 illustrated in FIG. 8 has substantially the same contents as that of the CEP engine rule rc_A1. The different point from the CEP engine rule rc_A1 is that the CEP engine condition of the CEP engine rule rc_A2 is “the average speed of truck events or car events is less than 50 km/hour, and weather forecast is rain”. Also, the dynamically change configuration conf_c illustrated in FIG. 8 indicates that the first event type is a truck event, and the second event type is a car event.

The server 201 refers to the CEP engine rule rc_A2, and the dynamically change configuration conf_c, and creates a filter engine rule that defines the condition for the first event type. The created result is rf_A2_1 illustrated in FIG. 8. The filter engine rule rf_A2_1 is a rule that defines extraction of the events having the average speed of less than 50 km/hour from the truck event, and the event having rain from the weather forecast events. Specifically, the server 201 extracts the condition of including the truck events set in the first event type of the dynamically change configuration conf_c from the CEP engine rule rc_A2, and creates the filter engine rule rf_A2_1. Then, when an event is input, the filter engine 211 applies the filter engine rule rf_A2_1 to extract the truck event, and the weather forecast event.

Also, the server 201 counts the number of inputs for each event type to which the input event belongs for each input of an event. Then, if the number of inputs of car events is larger than the number of inputs of truck events per unit time, the server 201 determines that the dynamically change condition is satisfied, and creates the filter engine rule that defines the condition of the car event type. Next, the server 201 changes the rule to be applied to the created rule.

The created result is rf_A2_2 illustrated in FIG. 8. The filter engine rule rf_A2_2 is a rule that extracts events having the average speed of less than 50 km/hour from the car events, and events having rain from the weather forecast events. Specifically, the server 201 changes the truck event of the filter engine rule rf_A2_1 with the car event set in the second event type of the dynamically change configuration conf_c so as to create the filter engine rule rf_A2_2. Then, when an event is input, the filter engine 211 applies the filter engine rule rf_A2_2 to extract the car event, and the weather forecast event.

FIG. 9 illustrates a specific example of changing filter engine rules by the number of input events per unit time. FIG. 9 illustrates the example illustrated in FIG. 8. The CEP engine rule rc_A2 becomes code epl_A2 illustrated in FIG. 9 in the EPL description. The server 201 refers to the dynamically change configuration conf_c, and extracts the truck event, the car event, and the weather forecast event from the code epl_A2 as the event types to use. The extracted result is list l_A2 illustrated in FIG. 9. Specifically, the server 201 extracts the event types excluding the car event set in the second event type from the code epl_A2. In the same manner as FIG. 6, the server 201 compares the event type definition e_def with the list l_A2, and identifies the car event as an unused event type.

Also, the server 201 refers to the dynamically change configuration conf_c, and extracts the condition for each event type from the where clause of the code epl_A2. Specifically, the server 201 extracts the condition of the events excluding the condition of the car event set in the second event type from the where clause of the code epl_A2. The result of condition extraction is the condition extraction result co_A2 illustrated in FIG. 9.

The server 201 creates the filter engine rule rf_A2_1 from the condition extraction result co_A2, and the identified unused event type. The filter engine rule rf_A2_1 becomes the code ift_A2_1 illustrated in FIG. 9 in the IF-THEN type rule description.

Also, although not illustrated in FIG. 9, the number of inputs of the car events is larger than the number of inputs of the truck events per unit time, the server 201 extracts the condition of the car event set in the second event type from the code epl_A2. Then, the server 201 refers to the dynamically change configuration conf_c, and replaces the truck event in the filter engine rule rf_A2_1 with the car event so as to create the filter engine rule rf_A2_2. The filter engine rule rf_A2_2 becomes the code ift_A2_2 illustrated in FIG. 9 in the IF-THEN type rule description.

Next, a description will be given of the case where when there are a plurality of CEP engine rules, a condition common to all the CEP engine rules is set, and if the common condition is not satisfied, all the events are discarded using FIG. 10 and FIG. 11. The condition common to all the CEP engine rules is called a “common condition to all the rules”.

FIG. 10 illustrates an example of setting a common condition to all the rules. If there are a plurality of CEP engine rules in addition to the functions described in FIG. 5 and FIG. 8, the server 201 sets a common condition to all the rules that is common to all the CEP engine rules.

For example, in the example in FIG. 10, two CEP engine rules, the CEP engine rule rc_A1, and the CEP engine rule rc_B1, which were set by the designer, are set in the CEP engine 212. The contents of the CEP engine rule rc_A1 is the same as those of the CEP engine rule rc_A1 illustrated in FIG. 5. The CEP engine rule rc_B1 includes the CEP engine condition that states “the average speed of the car events is less than 50 km/hour, and the weather forecast is rain”, and the CEP engine action that states “to recommend that “There is a possibility of the occurrence of a traffic jam””.

The server 201 identifies that “the weather forecast is rain” is the forming condition common to the CEP engine rules rc_A1, and rc_B1 from the analysis result of the CEP engine rule rc_A1 and the CEP engine rule rc_B1. When the server 201 makes identification, the server 201 sets the common condition to all the rules to “the weather forecast is rain”. Then, when events are input, the server 201 determines whether the common condition to all the rules, “the weather forecast is rain” is satisfied or not, and if not satisfied, all the input events are discarded. The discarded events are not sent to the filter engine 211, and the CEP engine 212.

FIG. 11 illustrates a specific example of setting a common condition among all the rules. FIG. 11 illustrates the specific example illustrated in FIG. 10. The CEP engine rule rc_A1 becomes the code epl_A1 illustrated in FIG. 11 in the EPL description. Also, the CEP engine rule rc_B1 becomes the code epl_B1 illustrated in FIG. 11 in the EPL description.

The server 201 extracts a condition for each event type from the where clause of the code epl_A1. The result of condition extraction is the condition extraction result condition extraction result co_A1 illustrated in FIG. 11. Also, the server 201 extracts a condition for each event type from the where clause of the code epl_B1. The result of condition extraction is the condition extraction result co_B1 illustrated in FIG. 11. Also, then, the server 201 identifies that the common forming condition is “SensorEvent.Rain=‘true’” from the condition extraction result co_A1, and the condition extraction result co_B1. After the server 201 identifies a common forming condition, the server 201 sets the common condition to all the rules to “SensorEvent.Rain=‘true’”.

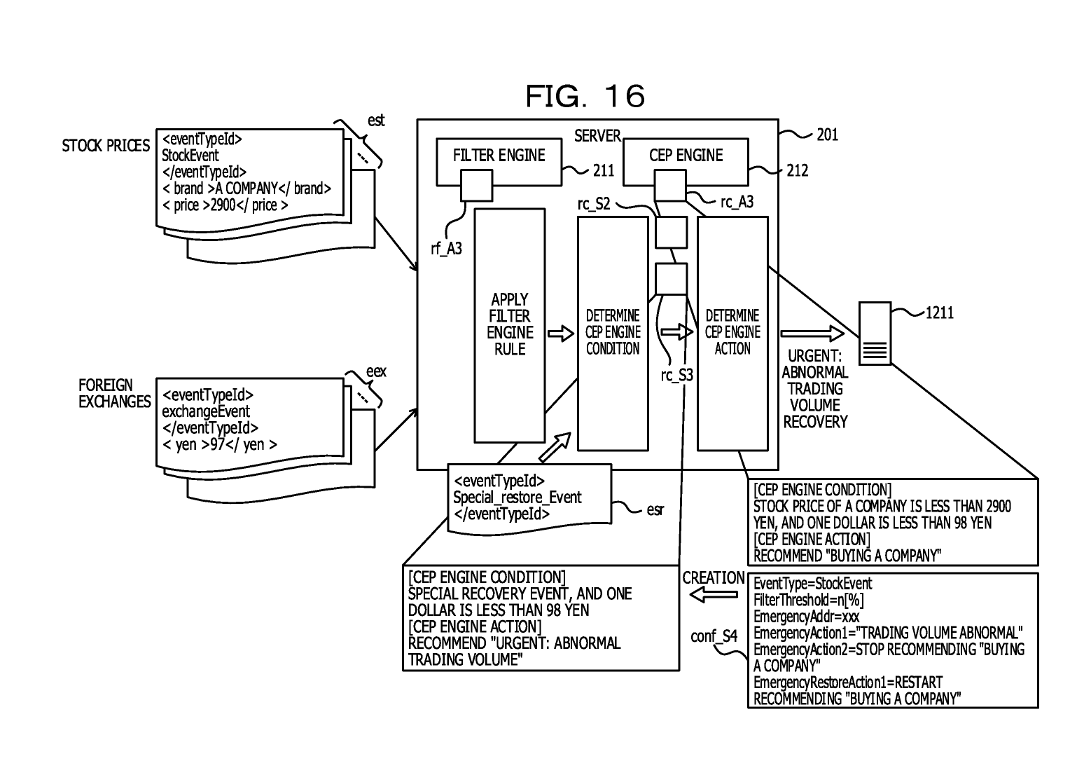

Next, a description will be given of an example in which when the filtering rate per unit time becomes lower than a threshold value for a certain event type, the events of the relevant event type are discarded, and a special event is issued using FIG. 12 to FIG. 15. Also, a description will be given of an example in which after a special event is issued, when the filtering rate per unit time becomes higher than a threshold value for a certain event type, a special recovery event is issued using FIG. 16.

The special event and the special recovery event are the events based on the comparison result between the number of extracted events belonging a specific event type by applying the filtering rule, and a predetermined threshold value. When the number of extracted events belonging to the specific event type becomes larger than the predetermined threshold value by applying the filtering rule, the filter engine 211 issues a special event. Also, after the special event is issued, when the number of extracted events belonging to the specific event type becomes lower than the predetermined threshold value by applying the filtering rule, the filter engine 211 issues a special recovery event.

FIG. 12 illustrates an example of issuing a special event. In addition to the functions described in FIG. 5, FIG. 8, and FIG. 10, when the filtering rate per unit time for the specific event type becomes lower than a threshold value, the server 201 discards the events belonging to the specific event type, and issues a special event. The filtering rate may be the remaining number of events with respect to the number of event groups to which the filter engine rule is applied, or the number of deleted events. In the present embodiment, the filtering rate is assumed to be the number of deleted events. That is to say, the case where the filtering rate becomes lower than the threshold value means that the number of deleted events is small, and the load of the CEP engine 212 increases. When the filtering rate becomes lower than the filtering rate threshold value set in the special event configuration, which was set by the traffic event information collection and detection system 200, the server 201 discards the events belonging to the relevant event type, and issues the special event.

For example, in the example in FIG. 12, the CEP engine rule rc_A1 is set in the CEP engine 212, which is set by the designer. The contents of the CEP engine rule rc_A1 is the same as those of the CEP engine rule rc_A1 illustrated in FIG. 5. Also, the filter engine rule rf_A1 created by the filter engine rule rf_A1 is set in the filter engine 211. The contents of the filter engine rule rf_A1 is the same as those of the filter engine rule rf_A1 illustrated in FIG. 5.

The special event configuration has setting items, such as EventType, FilterThreshold, and EmergencyAddr. EventType is an event type to be a target. FilterThreshold is a threshold value of the filtering rate per unit time of the event type to be a target. EmergencyAddr is an urgent destination to which a recommendation is notified when the filtering rate of an event belonging to the event type to be a target becomes lower than the threshold value set in FilterThreshold.

For example, the special event configuration conf_S1 illustrated in FIG. 12 indicates that the filtering rate threshold value is n [%], and if the filtering rate of the truck events becomes lower than n [%], a recommendation is notified to the destination “xxx”.

If there is a special event configuration, the server 201 creates a special event CEP engine rule from the CEP engine rule set by the designer. The special event CEP engine rule rc_S1 illustrated in FIG. 12 includes the CEP engine condition that states “special event, and the weather forecast is rain”, and the CEP engine action that states “to recommend “Urgent: “There is a possibility of the occurrence of a traffic jam””.

Specifically, first, the server 201 creates the condition produced by replacing the place corresponding to the truck event, which is set in the special event configuration conf_S1 with the special event among the CEP engine condition of the CEP engine rule rc_A1. That is to say, the server 201 replaces “the average speed of truck events is less than 50 km/hour, and the weather forecast is rain” with “special event, and the weather forecast is rain” for the CEP engine rule produced by copying the CEP engine rule rc_A1. Then, the server 201 adds “Urgent:” to the recommendation contents of the CEP engine action for the copied CEP engine rule. The created CEP engine rule is the CEP engine rule rc_S1 illustrated in FIG. 12.

Then, it is assumed that the filtering rate per unit time becomes lower than n [%] for the truck event having a threshold value to be monitored, which was set in the special event configuration conf_S1. At this time, the server 201 discards all the truck events, creates a special event esp, and transmits the special event esp to the CEP engine 212.

The CEP engine 212 that has received the special event esp applies the CEP engine rule rc_S1, and recommend “Urgent:“There is a possibility of the occurrence of a traffic jam”” to the urgent destination “xxx”.

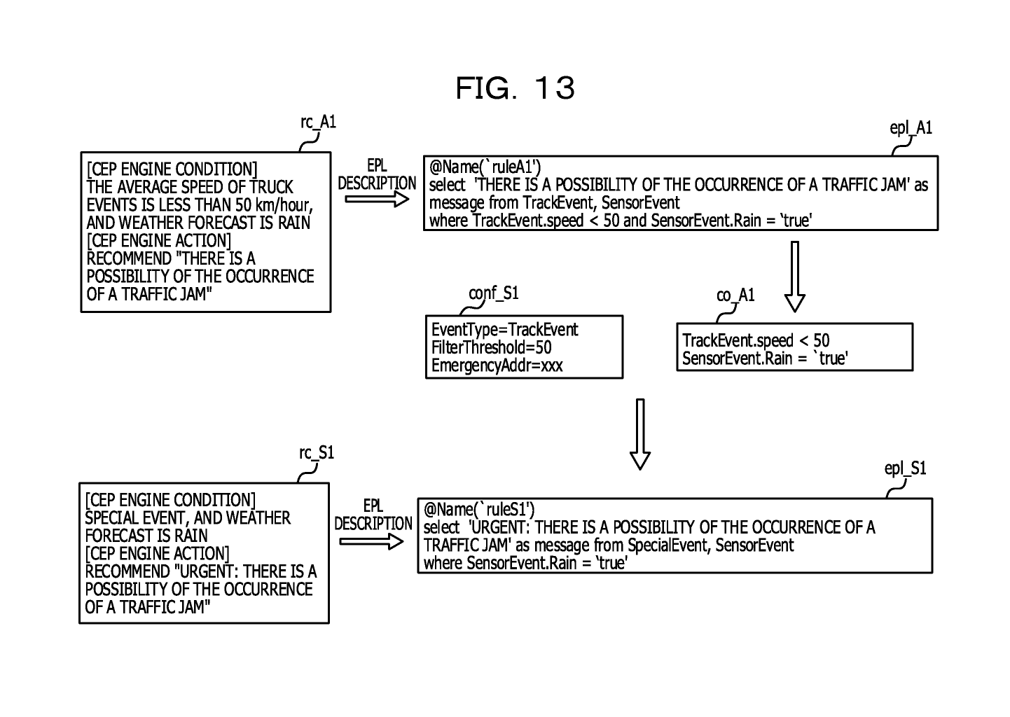

FIG. 13 illustrates a specific example of setting a special event. FIG. 13 illustrates the specific example illustrated in FIG. 12. The CEP engine rule rc_A1 becomes the code epl_A1 illustrated in FIG. 13 in the EPL description.

The server 201 extracts the condition from the where clause of the code epl_A1 for each event type. The result of condition extraction is the condition extraction result co_A1 illustrated in FIG. 13. Next, the server 201 refers to the special event configuration conf_S1, and creates CEP engine rule rc_S1 from the condition of the condition extraction result co_A1. The CEP engine rule rc_S1 becomes the code epl_S1 illustrated in FIG. 13 in the EPL description.

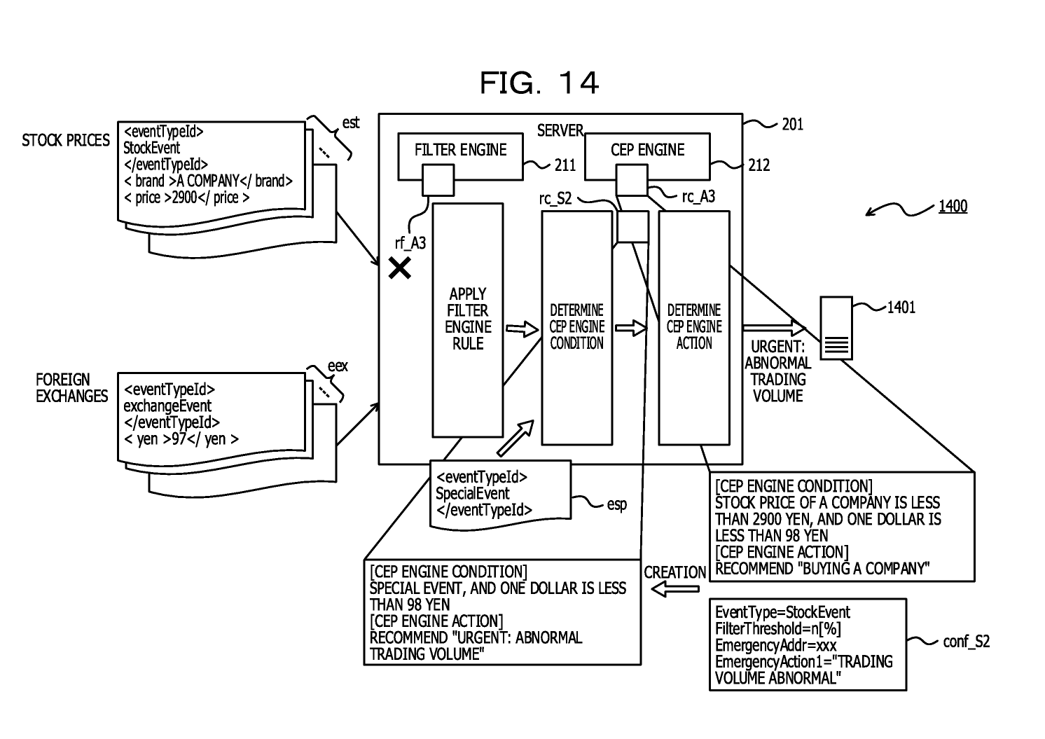

Next, another example of setting a special event using an example in which a complex event processing system is applied to a stock trading system with reference to FIG. 14 to FIG. 16.

FIG. 14 illustrates another example of setting a special event. A stock trading system 1400 is a system in which the server 201 receives stock price events est, and foreign exchange events eex as a plurality of events, and the server 201 issues a recommendation to a server 1401 of a securities company. In the following description and FIG. 14 to FIG. 16, a stock price event is sometimes described as “StockEvent”, and a foreign exchange event is sometimes described as “exchangeEvent”.

The server 201 performs syntax analysis on the CEP engine rule set by the designer to create a filter engine rule. Next, the server 201 extracts an event type to be used by the CEP engine rule from the analysis result by the CEP engine rule. Then, the server 201 creates a filter engine rule including the condition of the events to be extracted correspondingly to the event type from the extracted event type, and the condition to discard the unused event type.

The CEP engine rule rc_A3 illustrated in FIG. 14 has the CEP engine condition that states “The stock price of A Company is less than 2900 YEN, and one dollar is less than 98 YEN”, and the CEP engine action that states “to recommend “buying A Company”. Also, the filter engine rule rf_A3 illustrated in FIG. 14 is a rule defining extraction of events that are “A Company, and less than 2900 YEN” from the stock price events est, and extraction of events that are “one dollar is less than 98 YEN” from the foreign exchange events eex.

The special event configuration conf_S2 illustrated in FIG. 14 has EmergencyAction1 in addition to the special event configuration described in FIG. 12. EmergencyAction1 is an action at the time of the occurrence of a special event, which is to be performed at the time of lowering than the threshold value set in FilterThreshold.

For example, the special event configuration conf_S2 indicates that the filtering rate threshold value is n [%], and if the filtering rate of the stock price events est becomes lower than n [%], a recommendation that states “Urgent: abnormal trading volume” is notified to the destination “xxx”.

If there is a special event configuration, the server 201 creates a special event CEP engine rule from the CEP engine rule set by the designer. The special event CEP engine rule rc_S2 illustrated in FIG. 14 includes the CEP engine condition that states “one dollar is less than 98 YEN”, and the CEP engine action that states “to recommend “Urgent: abnormal trading volume”.

Specifically, first, the server 201 creates the condition produced by replacing the place corresponding to the truck event, which is set in the special event configuration conf_S2, with the special event esp among the CEP engine condition of the CEP engine rule rc_A3. That is to say, the server 201 replaces “The stock price of A Company is less than 2900 YEN, and one dollar is less than 98 YEN” with “special event, and one dollar is less than 98 YEN” for the CEP engine rule produced by copying the CEP engine rule rc_A3. Then, the server 201 replaces the recommendation contents of the CEP engine action for the copied CEP engine rule with the action set in the special event configuration conf_S2. That is to say, the server 201 replaces “buying A Company” with “Urgent: abnormal trading volume” for the CEP engine action copied from the CEP engine rule rc_A3. The created CEP engine rule is the CEP engine rule rc_S2 illustrated in FIG. 14.

It is assumed that the filtering rate per unit time becomes lower than n [%] for the stock price having a threshold value to be monitored, which was set in the special event configuration conf_S2. At this time, the server 201 discards all the truck events, creates a special event esp, and transmits the special event esp to the CEP engine 212.

The CEP engine 212 that has received the special event esp applies the CEP engine rule rc_S2, and recommends “Urgent: abnormal trading volume” to the urgent destination “xxx”. In this manner, the stock trading system 1400 is capable of detecting the occurrence of sell orders of A Company, which is beyond expectation.

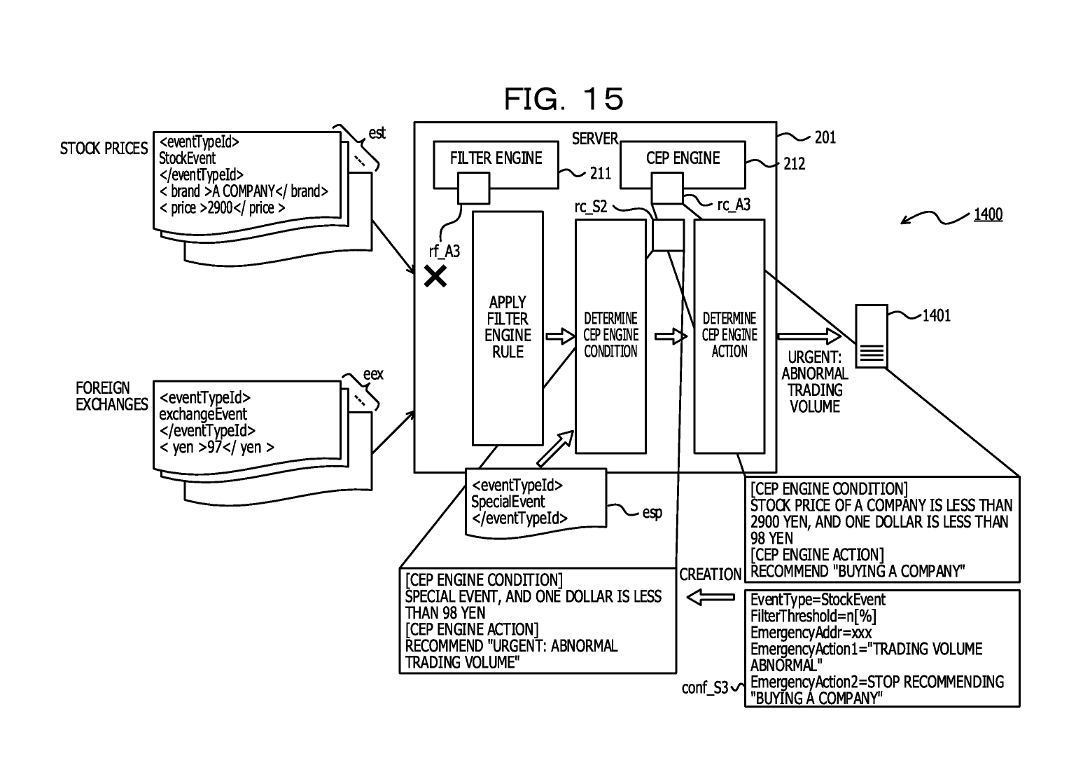

FIG. 15 illustrates another specific example of setting a special event. The stock trading system 1400 illustrated in FIG. 15 stops the recommendation of “buying A Company” when a special event esp occurs.

The special event configuration conf_S3 illustrated in FIG. 15 has EmergencyAction2 in addition to the special event configuration conf_S2 described in FIG. 14. EmergencyAction2 is an action at the time of the occurrence of a special event, which is to be performed at the time of lowering than the threshold value set in FilterThreshold.

For example, the special event configuration conf_S3 indicates stopping the recommendation of “buying A Company” when the filtering rate becomes lower than the threshold value set in FilterThreshold in addition to the matter indicated by the special event configuration conf_S2.

The CEP engine 212 that has received the special event esp applies the CEP engine rule rc_S2, and recommends “Urgent: abnormal trading volume” to the urgent destination “xxx”. Further, the CEP engine 212 stops the recommendation of “buying A Company” even if the filtering rate returns to normal. In this manner, even if the stock trading system 1400 detects the occurrence of sell orders of A Company, which is beyond expectation, and the filtering rate returns to normal, the market on that day is abnormal, and thus it is possible to withhold trade.

FIG. 16 illustrates an example of setting a special recovery event. The stock trading system 1400 illustrated in FIG. 16 restarts the recommendation of “buying A Company” at the time when filtering rate returns to normal after the occurrence of the special event esp.

The special event configuration conf_S4 illustrated in FIG. 16 has EmergencyRestoreAction1 in addition to the special event configuration conf_S3 described in FIG. 15. EmergencyRestoreAction1 is an action at the time of the occurrence of a special recovery event, which is to be performed at the time when the filtering rate once lowers than the threshold value set in FilterThreshold, and then, becomes equal to or higher than the threshold value.

For example, the special event configuration conf_S4 indicates restarting the recommendation of “buying A Company” when the filtering rate becomes lower than the threshold value set in FilterThreshold, and then becomes equal to or higher than the threshold value in addition to the matter indicated by the special event configuration conf_S3.

If there is a special event configuration, and an action at the time of the occurrence of the special recovery event is set, the server 201 creates a special event CEP engine rule from the CEP engine rule set by the designer. The special event CEP engine rule rc_S3 illustrated in FIG. 16 includes the CEP engine condition that states “one dollar is less than 98 YEN”, and the CEP engine action that states “to recommend “Urgent: abnormal trading volume recovery””.

It is assumed that the filtering rate per unit time becomes lower than n [%] for the stock price event having a threshold value to be monitored, which was set in the special event configuration conf_S4, and then becomes equal to or higher than the threshold value. At this time, the server 201 cancels discarding the stock price event est, creates a special recovery event esr, and transmits the special recovery event esr to the CEP engine 212.

The CEP engine 212 that has received the special recovery event esr applies the CEP engine rule rc_S3, issues the recommendation of “Urgent: abnormal trading volume recovery”, and restarts the recommendation of “buying A Company”. In this manner, it is possible for the stock trading system 1400 to assume that the market has returned to normal after the occurrence of sell orders of A Company beyond expectation, and to restart trading.

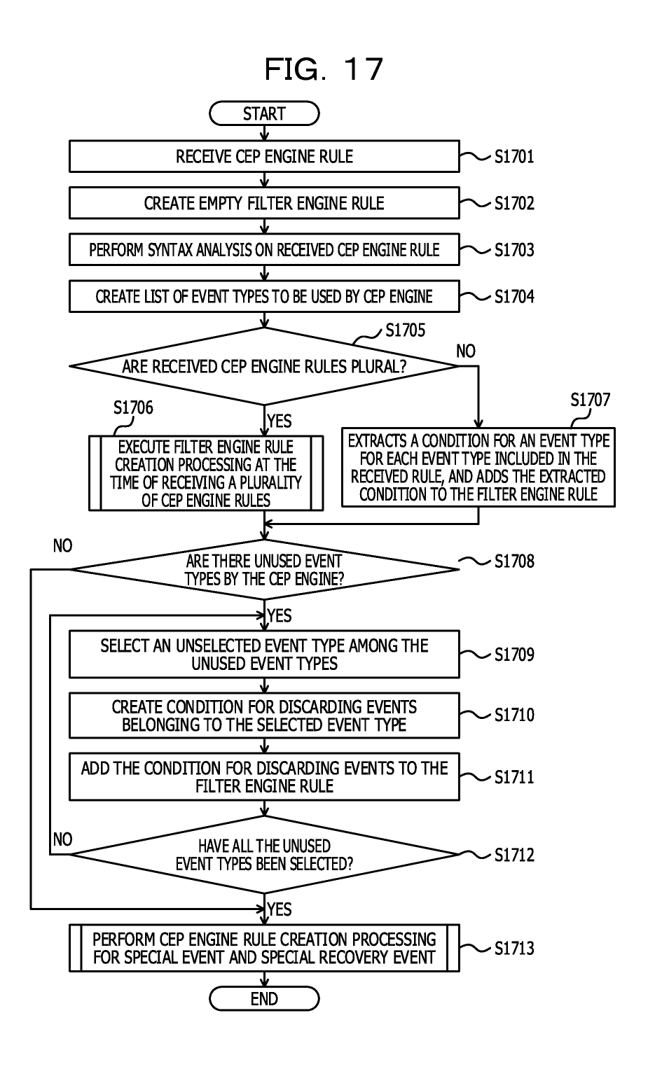

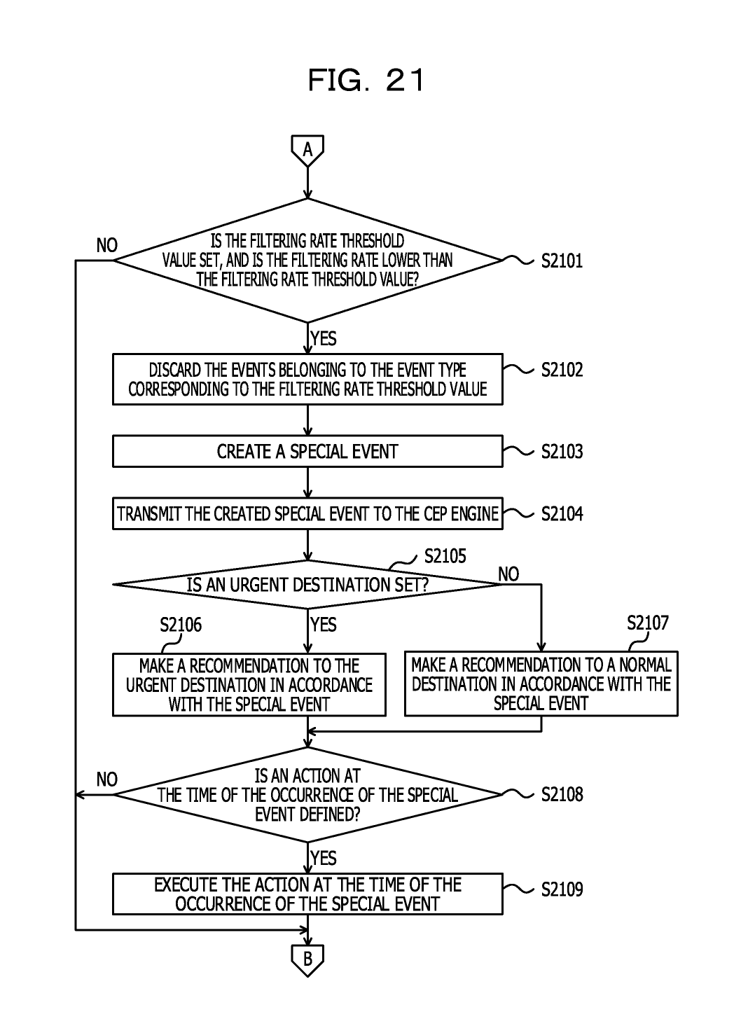

Next, a description will be given of flowcharts of event-input preprocessing, and event-input time processing using FIG. 17 to FIG. 22. The control process in the server 201 executes the event-input preprocessing. Also, the filter engine 211 and the CEP engine 212 execute the event-input time processing in collaboration.

FIG. 17 is a flowchart illustrating an event-input preprocessing procedure. The event-input preprocessing is the processing performed before events are input. The control process receives a CEP engine rule (step S1701). Next, the control process creates an empty filter engine rule (step S1702). Then, the control process performs syntax analysis on the received CEP engine rule (step S1703). Next, the control process creates a list of event types to be used by the CEP engine 212 (step S1704).

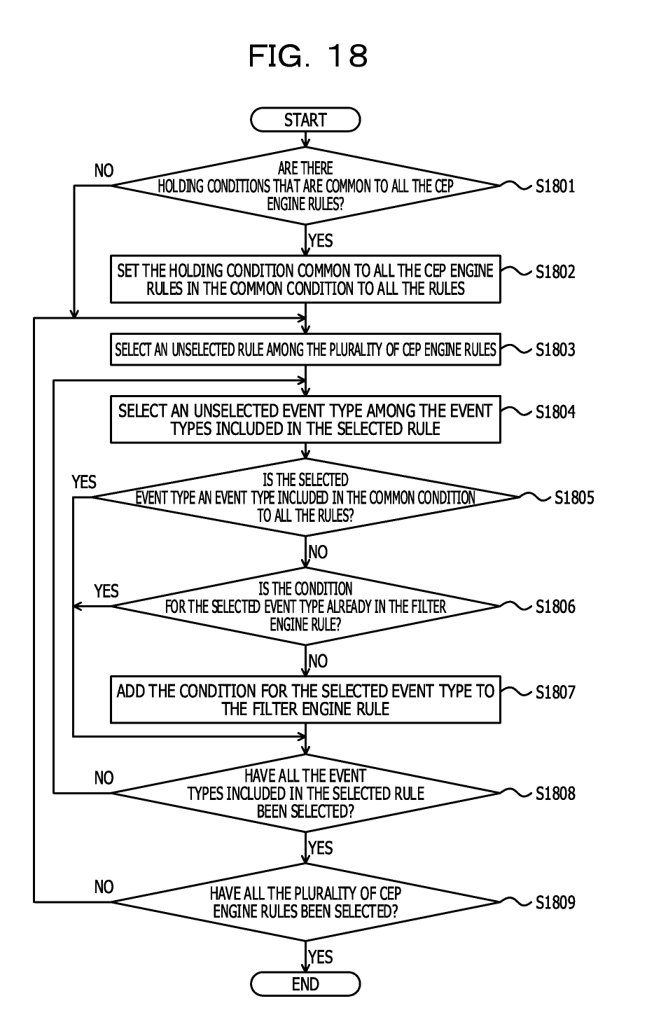

Then, the control process determines whether the received CEP engine rules are plural or not (step S1705). If the received CEP engine rules are plural (step S1705: Yes), the control process executes the filter engine rule creation processing at the time of receiving a plurality of CEP engine rules (step S1706). The filter engine rule creation processing at the time of receiving a plurality of CEP engine rules will be described later using FIG. 18.

On the other hand, if the number of received CEP engine rules is one (step S1705: No), the control process extracts a condition for an event type for each event type included in the received rule, and adds the extracted condition to the filter engine rule (step S1707).

After the processing in step S1706 or step S1707 is completed, the control process determines whether there are unused event types by the CEP engine (step S1708). If there are unused event types by the CEP engine (step S1708: Yes), the control process selects an unselected event type among the unused event types (step S1709). Next, the control process creates the condition for discarding events belonging to the selected event type (step S1710). The method of creating a specific condition is as described in FIG. 7.

Then, the control process adds the condition for discarding events to the filter engine rule (step S1711). Next, the control process determines whether all the unused event types have been selected or not (step S1712). If there is still an unselected event type (step S1712: No), the control process proceeds to the processing in step S1709.

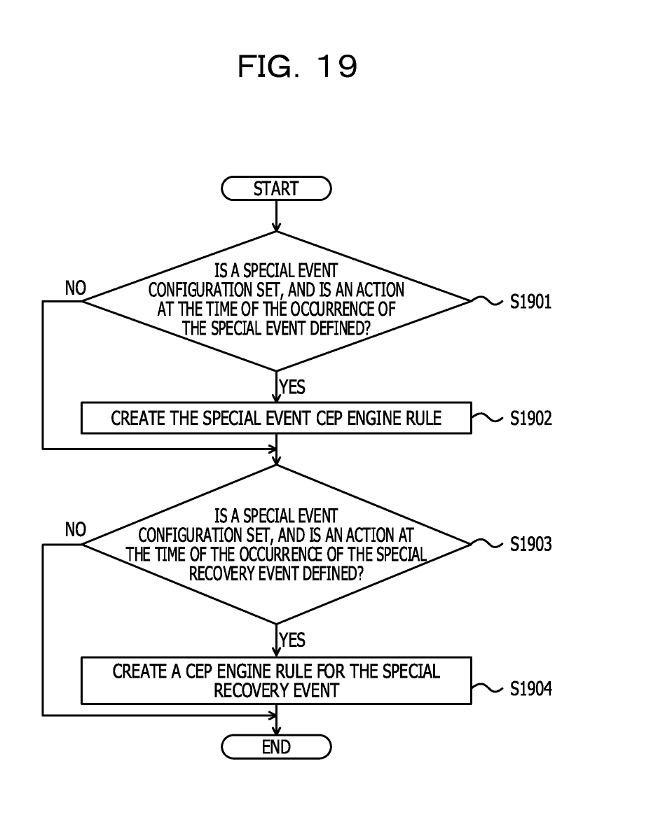

If all the unused event types have been selected (step S1712: Yes), or if there are no unused event types by the CEP engine (step S1708: No), the control process executes the CEP engine rule creation processing for the special event and the special recovery event (step S1713). The detailed description will be given later of the CEP engine rule creation processing for the special event, and the special recovery event using FIG. 19. After the processing in step S1713 is completed, the control process terminates the event-input preprocessing. By executing the event-input preprocessing, it is possible for the server 201 to create a filter engine rule corresponding to the CEP engine rule set by the designer of the traffic event information collection and detection system 200.

FIG. 18 is a flowchart illustrating an example of a filter engine rule creation processing procedure at the time of receiving a plurality of CEP engine rules. The filter engine rule creation processing at the time of receiving a plurality of CEP engine rules is processing for creating a filter engine rules when receiving a plurality of CEP engine rules.

The control process determines whether there are forming conditions that are common to all the CEP engine rules (step S1801). If there is a forming condition common to all the CEP engine rules (step S1801: Yes), the control process sets the forming condition common to all the CEP engine rules in the common condition to all the rules (step S1802).

After the processing in step S1802 is completed, or there are no forming conditions that are common to all the CEP engine rules (step S1801: No), the control process selects an unselected rule among the plurality of CEP engine rules (step S1803). Then, the control process selects an unselected event type among the event types included in the selected rule (step S1804).

Next, the control process determines whether the selected event type is an event type included in the common condition to all the rules (step S1805). If the selected event type is not an event type included in the common condition to all the rules (step S1805: No), the control process next determines whether the condition for the selected event type is already in the filter engine rule or not (step S1806). If there are no conditions for the selected event type in the filter engine rule (step S1806: No), the control process adds the condition for the selected event type to the filter engine rule (step S1807).

After the processing in step S1807 is completed, either in the case where the selected event type is an event type included in the common condition to all the rules (step S1805: Yes), or in the case where the selected event type is already in the filter engine rule (step S1806: Yes), the control process determines whether all the event types included in the selected rule have been selected or not (step S1808). If step S1806 is Yes, the control process may output the selected event type in order to indicate that there is a problem in the CEP engine rule.

If there is still an unselected event type (step S1808: No), the control process proceeds to the processing in step S1804. On the other hand, if all the event types included in the selected rule have been selected (step S1808: Yes), the control process next determines whether all the plurality of CEP engine rules have been selected or not (step S1809). If there is still an unselected CEP engine rule (step S1809: No), the control process proceeds to the processing in step S1803. On the other hand, if all of the plurality of CEP engine rules have been selected (step S1809: Yes), the control process terminates the filter engine rule creation processing at the time of receiving a plurality of CEP engine rules. Thereby, it is possible for the control process to create a filter engine rule corresponding to the plurality of CEP engine rules set by the designer of the traffic event information collection and detection system 200.

FIG. 19 is a flowchart illustrating an example of a CEP engine rule creation processing procedure for a special event, and a special recovery event. The CEP engine rule creation processing for a special event, and a special recovery event is processing performed before events are input.

The control process determines whether a special event configuration is set, and an action at the time of the occurrence of the special event is defined or not (step S1901). If the action at the time of the occurrence of the special event is defined (step S1901: Yes), the control process creates the special event CEP engine rule (step S1902).

After the processing in step S1902 is completed, or if a special event configuration is not set, or an action at the time of the occurrence of the special event is not defined (step S1901: No), the control process proceeds to the processing in step S1903. The control process determines whether a special event configuration is set, and an action at the time of the occurrence of the special recovery event is defined or not (step S1903). If the action at the time of the occurrence of the special recovery event is defined (step S1903: Yes), the control process creates a CEP engine rule for the special recovery event (step S1904).

After the processing in step S1904 is completed, or if a special event configuration is not set, or at the time of the occurrence of the special recovery event is not defined (step S1903: No), the control process terminates the CEP engine rule creation processing for the special event, and the special recovery event. By executing the CEP engine rule creation processing for the special event, and the special recovery event, it is possible for the control process to create the CEP engine rule creation processing for the special event, and the special recovery event.

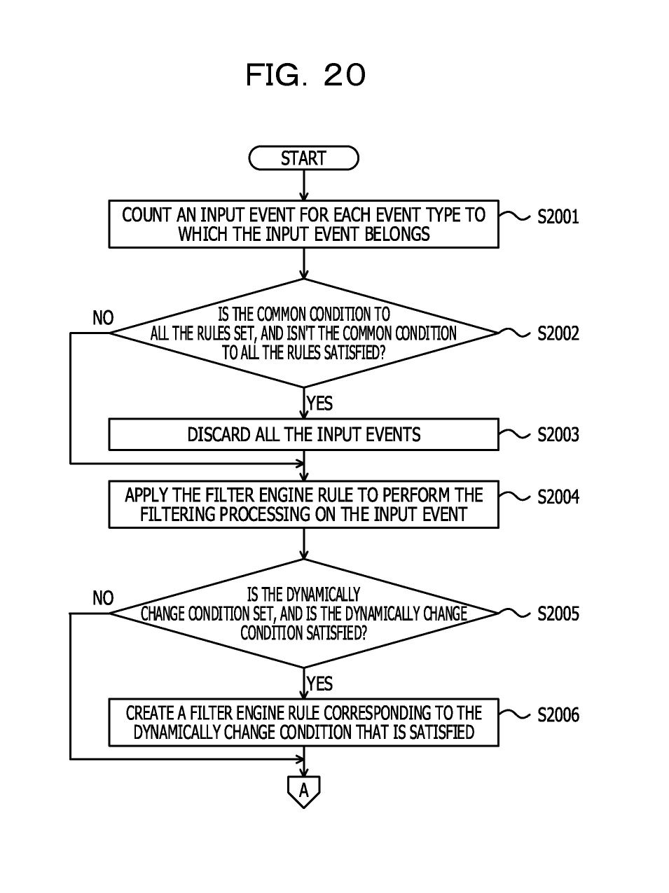

FIGS. 20, 21 and 22 are flowcharts illustrating an example of an event-input time processing procedure. The event-input time processing is processing performed at the time of inputting events. The filter engine 211 counts an input event for each event type to which the input event belongs (step S2001). Next, the filter engine 211 determines whether the common condition to all the rules is set, and the common condition to all the rules is not satisfied (step S2002). If the common condition to all the rules is not satisfied (step S2002: Yes), the filter engine 211 discards all the input events (step S2003).

After the processing in step S2003 is completed, or the common condition to all the rules is not set, or the common condition to all the rules is satisfied (step S2002: No), the filter engine 211 applies the filter engine rule to perform the filtering processing on the input event (step S2004). Next, the filter engine 211 determines whether the dynamically change condition is set, and the dynamically change condition is satisfied (step S2005). If the dynamically change condition is satisfied (step S2005: Yes), the filter engine 211 creates a filter engine rule corresponding to the dynamically change condition that is satisfied (step S2006).

After the processing in step S2006 is completed, or the dynamically change condition is not set, or the dynamically change condition is not satisfied (step S2005: No), the filter engine 211 determines whether the filtering rate threshold value is set, and the filtering rate is lower than the filtering rate threshold value (step S2101). If the filtering rate is lower than the filtering rate threshold value (step S2101: Yes), the filter engine 211 discards the events belonging to the event type corresponding to the filtering rate threshold value (step S2102). Next, the filter engine 211 creates a special event (step S2103). Then, the filter engine 211 transmits the created special event to the CEP engine 212 (step S2104).

The CEP engine 212 that has received the special event determines whether an urgent destination is set or not (step S2105). If an urgent destination is set (step S2105: Yes), the CEP engine 212 makes a recommendation to the urgent destination in accordance with the special event (step S2106). On the other hand, if an urgent destination is not set (step S2105: No), the CEP engine 212 makes a recommendation to a normal destination in accordance with the special event (step S2107).

After the processing in step S2106, or step S2107 is completed, the CEP engine 212 determines whether an action at the time of the occurrence of the special event is defined or not (step S2108). If the action the time of the occurrence of the special event is defined (step S2108: Yes), the CEP engine 212 executes the action at the time of the occurrence of the special event (step S2109). On the other hand, if the action the time of the occurrence of the special event is not defined (step S2108: No), the CEP engine 212 waits for an event from the filter engine 211.

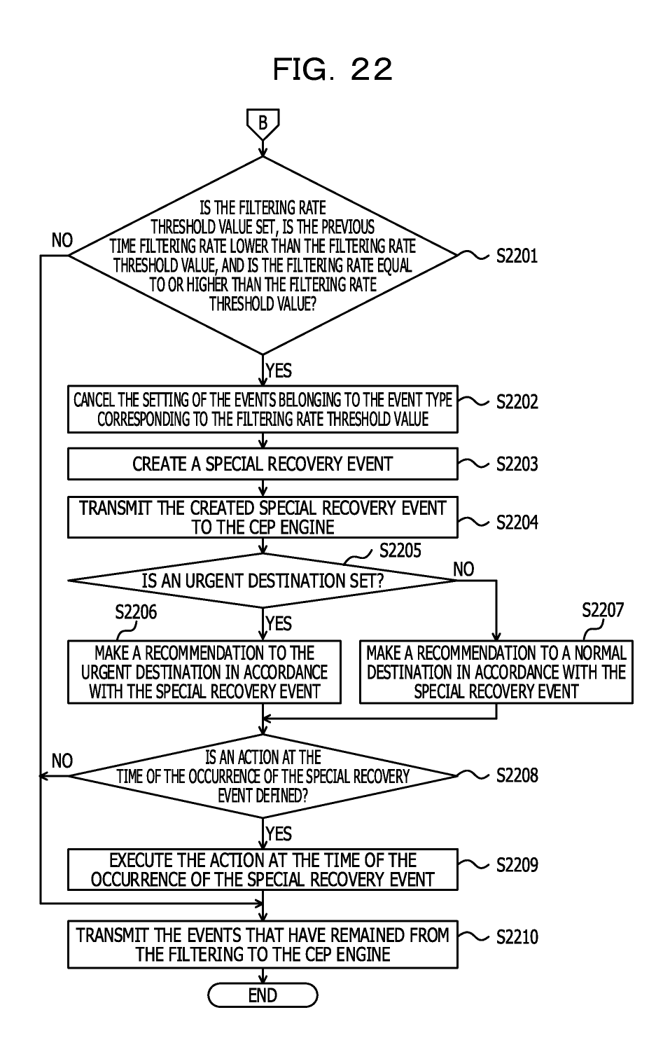

If the filtering rate threshold value is not set, or the filtering rate is equal to or higher than the filtering rate threshold value (step S2101: No), or after the processing in step S2109 is completed, the filter engine 211 executes the processing in step S2201 illustrated in FIG. 22.

The filter engine 211 determines whether the filtering rate threshold value is set, the previous time filtering rate is lower than the filtering rate threshold value, and the filtering rate is equal to or higher than the filtering rate threshold value (step S2201). If the filtering rate is equal to or higher than filtering rate threshold value (step S2201: Yes), the filter engine 211 cancels the setting of the events belonging to the event type corresponding to the filtering rate threshold value (step S2202).

Next, the filter engine 211 creates a special recovery event (step S2203). Then, the filter engine 211 transmits the created special recovery event to the CEP engine 212 (step S2204).

The CEP engine 212 that has received the special recovery event determines whether an urgent destination is set or not (step S2205). If an urgent destination is set (step S2205: Yes), the CEP engine 212 makes a recommendation to the urgent destination in accordance with the special recovery event (step S2206). On the other hand, if an urgent destination is not set (step S2205: No), the CEP engine 212 makes a recommendation to the normal destination in accordance with the special recovery event (step S2207).

After the processing in step S2206, or step S2207 is completed, the CEP engine 212 determines whether an action at the time of the occurrence of the special recovery event is defined or not (step S2208). If an action at the time of the occurrence of the special recovery event is defined (step S2208: Yes), the CEP engine 212 executes the action at the time of the occurrence of the special recovery event (step S2209). After the processing in step S2209 is completed, or if an action at the time of the occurrence of the special recovery event is not defined (step S2208: No), the CEP engine 212 waits for an event from the filter engine 211.

If the filtering rate threshold value is not set, or the previous time filtering rate is not lower than the filtering rate threshold value, or the filtering rate is less than the filtering rate threshold value (step S2201: No), the filter engine 211 proceeds to the processing in step S2210. Also, after the processing in step S2204, the filter engine 211 proceeds to the processing in step S2210. The filter engine 211 transmits the events that have remained from the filtering to the CEP engine 212 (step S2210). By executing the event-input time processing, it is possible for the server 201 to perform processing on the event group using the CEP engine rule, the filter engine rule, the CEP engine rule for the special event, and the CEP engine rule for the special recovery event.

As described above, with the server 201 according to the present embodiment, a filter engine rule is created that extracts each event type condition from a CEP engine rule, and extracts data satisfying the condition of each event type. Thereby, it is possible for the server 201 according to the present embodiment to automatically create a filter engine rule, and to reduce the load of the rule creation work of a designer of the traffic event information collection and detection system 200. Also, the created filter engine rule extracts only valid events from event group, and thus the load imposed on the CEP engine 212 is suppressed, and deterioration of precision of the analysis result of the CEP engine 212 is restrained. Also, the server 201 according to the present embodiment makes it possible to execute processing of big data, that is to say, a large volume of events, at a low cost.

Also, the created filter engine rule may be applied to an event group so that data to be an application target of the CEP engine rule is extracted from the event group. Thereby, the operation of updating a filter engine rule each time the CEP engine rule is changed is carried out automatically, and thus the workload of an administrator of the traffic event information collection and detection system 200 is reduced.

Also, a filter engine rule may be applied to an event group based on the number of pieces of data belonging to each event type. Thereby, the optimality of the filter engine rule is maintained correspondingly to a change in the event type of the input event group.

Also, if an event group does not satisfy the condition concerning the events belonging to the common event type to a plurality of CEP engine rules, the event group may be discarded. In this manner, when an event group is deleted, the load of the CEP engine 212 is reduced. Further, before a filter engine rule is applied, a determination may be made that the condition is not satisfied concerning the events of the common event type to a plurality of CEP engine rules. When an event group is deleted based on such a determination, the load imposed on the filter engine 211 is reduced.

Also, the server 201 according to the present embodiment creates a condition including the existence of a special event, and a CEP engine rule that defines the action corresponding to the comparison result expressed by the special event when the condition is satisfied. The special event may be created based on the number of events extracted by the application of the filter engine rule, and the comparison result with a predetermined threshold value. For example, a notification of data indicating the comparison result is received by an administrator, so that it is possible for the administrator to detect that the filter engine functions normally, or the filtering rate decreases so that the load imposed on the CEP engine 212 increases.

Also, if the number of events extracted from an event group by the application of a filter engine rule is larger than the predetermined threshold value, the server 201 according to the present embodiment may discard the event group, and may create data indicating that the number of pieces of extracted data is larger than the predetermined threshold value. Thereby, when the load of the CEP engine 212 increases with a decrease in the filtering rate, it is possible to notify the decrease of the filtering rate to the outside, and the load imposed on the CEP engine 212 is suppressed.

In this regard, the rule creation method described in the present embodiment is achieved by executing a rule creation program provided in advance on a computer, such as a personal computer, a workstation, or the like. The rule creation program is recorded in a computer-readable recording medium, such as a hard disk, a flexible disk, a compact disc-read only memory (CD-ROM), a digital versatile disk (DVD), or the like, and then is read from the recording medium by a computer to be executed. Also, the rule creation program may be distributed through a network, such as the Internet, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of creating rule information, the method comprising:
from a complex rule defining a complex condition being a combination of conditions on event data individually belonging to each of a plurality of event data classes, and a complex rule defining a predetermined action when the complex condition is satisfied, first extracting a condition on event data belonging to each of the event data classes from the complex condition; and
creating an extraction rule for extracting event data to be an application target of the complex rule satisfying the extracted condition from an event data group.

2. The method according to claim 1, further comprising:
by applying the created extraction rule to the event data group, second extracting event data to be an application target of the complex rule from the event data group.

3. The method according to claim 2, further comprising:
third extracting another condition on the event data belonging to the event data class common to the complex condition of each of the plurality of complex rules from the plurality of the complex rules; and
after executing the third extracting, discarding the event data group when there is no event data satisfying the other condition among the event data group.

4. The method according to claim 2, further comprising:
based on a predetermined threshold value corresponding to a specific event data class, and the complex rule, creating a new complex rule defining a complex condition combining a first condition including existence of specific data based on a comparison result between a number of extracting event data belonging to the specific event data class and the predetermined threshold value, and a second condition on event data belonging to a different event data class from the specific event data class included in the complex rule, and an action corresponding to the comparison result when the complex condition is satisfied;
applying the extraction rule to the event data group;
creating the specific data based on the comparison result between a number of pieces of event data belonging to the specific event data class extracted from the event data group by the applying, and the predetermined threshold value; and
setting the event data extracted from the event data group by the applying, and the specific data to an application target of the new complex rule.

5. The method according to claim 4, further comprising:
discarding event data belonging to the specific event data class among the event data group when the number is higher than the predetermined threshold value; and
setting event data excluding the event data discarded by the discarding among the event data extracted from the event data group by the applying, and the specific data to an application target of the new complex rule.

6. The method according to claim 1, wherein
the creating creates the extraction rule based on a number of pieces of event data belonging to each of the event data classes included in the event data group.

7. An apparatus comprising:
a memory; and
a processor coupled to the memory and configured to:
from a complex rule defining a complex condition being a combination of conditions on event data individually belonging to each of a plurality of event data classes, and a complex rule defining a predetermined action when the complex condition is satisfied, extract a condition on event data belonging to each of the event data classes from the complex condition, and
create an extraction rule for extracting event data to be an application target of the complex rule satisfying the extracted condition from an event data group.

8. The apparatus according to claim 7, wherein the processor is configured to:
by applying the created extraction rule to the event data group, extract event data to be an application target of the complex rule from the event data group.

9. The apparatus according to claim 8, wherein the processor is configured to:
extract another condition on the event data belonging to the event data class common to the complex condition of each of the plurality of complex rules from the plurality of the complex rules, and
after executing the another condition, discard the event data group when there is no event data satisfying the other condition among the event data group.

10. The apparatus according to claim 8, wherein the processor is configured to:
based on a predetermined threshold value corresponding to a specific event data class, and the complex rule, create a new complex rule defining a complex condition combining a first condition including existence of specific data based on a comparison result between a number of extracting event data belonging to the specific event data class and the predetermined threshold value, and a second condition on event data belonging to a different event data class from the specific event data class included in the complex rule, and an action corresponding to the comparison result when the complex condition is satisfied,
apply the extraction rule to the event data group,
create the specific data based on the comparison result between a number of pieces of event data belonging to the specific event data class extracted from the event data group by applying of the extraction rule, and the predetermined threshold value, and
set the event data extracted from the event data group by applying of the extraction rule, and the specific data to an application target of the new complex rule.

11. The apparatus according to claim 10, wherein the processor is configured to:
discard event data belonging to the specific event data class among the event data group when the number is higher than the predetermined threshold value, and
set event data excluding the event data discarded by the discarding among the event data extracted from the event data group by applying of the extraction rule, and the specific data to an application target of the new complex rule.

12. The apparatus according to claim 7, wherein the processor is configured to:
create the extraction rule based on a number of pieces of event data belonging to each of the event data classes included in the event data group.

13. A non-transitory storage medium that stores a program for causing a computer to execute a process, the process comprising:
from a complex rule defining a complex condition being a combination of conditions on event data individually belonging to each of a plurality of event data classes, and a complex rule defining a predetermined action when the complex condition is satisfied, first extracting a condition on event data belonging to each of the event data classes from the complex condition; and
creating an extraction rule for extracting event data to be an application target of the complex rule satisfying the extracted condition from an event data group.

14. The non-transitory storage medium according to claim 13, wherein the process further comprising:
by applying the created extraction rule to the event data group, second extracting event data to be an application target of the complex rule from the event data group.

15. The non-transitory storage medium according to claim 14, wherein the process further comprising:
third extracting another condition on the event data belonging to the event data class common to the complex condition of each of the plurality of complex rules from the plurality of the complex rules; and
after executing the third extracting, discarding the event data group when there is no event data satisfying the other condition among the event data group.

16. The non-transitory storage medium according to claim 14, wherein the process further comprising:
based on a predetermined threshold value corresponding to a specific event data class, and the complex rule, creating a new complex rule defining a complex condition combining a first condition including existence of specific data based on a comparison result between a number of extracting event data belonging to the specific event data class and the predetermined threshold value, and a second condition on event data belonging to a different event data class from the specific event data class included in the complex rule, and an action corresponding to the comparison result when the complex condition is satisfied;
applying the extraction rule to the event data group;
creating the specific data based on the comparison result between a number of pieces of event data belonging to the specific event data class extracted from the event data group by the applying, and the predetermined threshold value; and
setting the event data extracted from the event data group by the applying, and the specific data to an application target of the new complex rule.

17. The non-transitory storage medium according to claim 16, wherein the process further comprising:
discarding event data belonging to the specific event data class among the event data group when the number is higher than the predetermined threshold value; and
setting event data excluding the event data discarded by the discarding among the event data extracted from the event data group by the applying, and the specific data to an application target of the new complex rule.

18. The non-transitory storage medium according to claim 13, wherein
the creating creates the extraction rule based on a number of pieces of event data belonging to each of the event data classes included in the event data group.
